(19) United States
(12) Patent Application Publication
(10) Pub. No.: US 2012/0251641 A1
(43) Pub. Date: Oct. 4, 2012

(54) METHODS FOR PEST CONTROL EMPLOYING MICROEMULSION-BASED ENHANCED PEST CONTROL FORMULATIONS

(75) Inventors: Essam Enan, Davis, CA (US); Peter J. Porpiglia, Putnam Valley, NY (US); Gregory J. Lindner, Wilmington, DE (US)

(73) Assignee: TYRA TECH, INC,, Morrisville, NC (US)

(21) Appl. No.: 13/262,197

(22) PCT Filed: Apr. 1, 2010
(86) PCT No.: PCT/US10/29724

§ 371 Date: Apr. 20, 2012

Related U.S. Application Data
(60) Provisional application No. 61/166,634, filed on Apr. 3, 2009.

(51) Int. Cl. A01N 65/22; A01P 7/04; A01N 25/02

(52) U.S. Cl. 424/745; 514/784

(57) ABSTRACT

A method of controlling a target pest is disclosed that comprises providing a microemulsion pesticide formulation comprising an active pest control ingredient and a microemulsifying agent, wherein the microemulsifying agent comprises a mixture of unsaturated C12-C26 fatty acids and/or salts thereof and saturated C6-C14 fatty acids and/or salts thereof, and the active pest control ingredient comprises two or more compounds that act synergistically to control the target pest; and applying an effective amount of the microemulsion pesticide formulation to the target pest or to a surface associated with the target pest. The active pest control ingredient and the microemulsifying agent may act synergistically in the method to control the target pest. The control exhibited by the formulation may be knockdown, kill, or repellency. The method may involve long-term residual effects.

### RELATED APPLICATIONS

This application claims the benefit of U.S. Provisional Patent Application No. 61/166,634, filed Apr. 3, 2009, the entire text whereof is incorporated by reference into the present application.

### FIELD OF THE INVENTION

The present invention relates to methods of pest control employing compositions comprising certain essential oils formulated as microemulsions using an emulsifying agent comprising a mixture of unsaturated C12-C26 fatty acids and/or salts thereof and saturated C6-C14 fatty acids and/or salts thereof.

### BACKGROUND

While the first recorded use of chemicals to control pests dates back to 2500 BC, only in the last 60 years has chemical control been widely used. Early pesticides included hellebore to control body lice, nicotine to control aphids, and pyrethrin to control a wide variety of insects. Lead arsenate was first used in 1892 as an orchard spray, while at the same time it was discovered that a mixture of lime and copper sulphate (Bordeaux mixture) controlled downy mildew, a fungal disease of grapes. Many of the more recent pesticides have been developed to target specific biochemical reactions within the target organism, e.g. an enzyme necessary for photosynthesis within a plant or a hormone required for normal development in an insect.

Recently, there has been increased research into the deleterious effects of chemical pesticides, with concomitant efforts to develop safer alternatives to current commercial pesticides. Some of this research has focused on the use of natural products, such as combinations of chemicals obtained from plants, such as essential oils.

Microemulsions are clear uniform liquid mixtures of oil, water and surfactant. In more detail, a microemulsion is a thermodynamically stable dispersion of two immiscible liquids, stabilized by surfactants; it is typically clear because the dispersed droplets are less than 100 nanometers in diameter. In general, microemulsions offer the advantages of low irritancy, low non-target toxicity, high biodegradability, no need for solvents, no odors, and no residual deposits. In part, because the surfactant component is a wetting agent that lowers the surface tension of liquid, microemulsions tend to consist of a mixture that can be spread easier than other mixtures and thus provide greater surface area. Methods by which microemulsions can be prepared are generally well understood by those of skill in the art and microemulsion formulations appear to be an emerging standard for the formulation of hydrophobic pesticides in water-based carriers.

In addition, suspension concentrates, dispersions of sparingly soluble active ingredients in water or in organic solvents, are also employed in conjunction with pesticidal compositions. Suspension concentrate pesticidal compositions are concentrated suspensions of water-insoluble pesticides, frequently containing 10% to 80% by weight of pesticides, and can provide a method of handling relatively water-insoluble pesticides in an aqueous medium. In general, it can be desirable to formulate pesticides in a suspension concentrates due to the advantage of not requiring the use of organic solvents, often present in emulsifiable concentrates.

Furthermore, pesticides can also take the form of suspoemulsions, also known as suspension emulsions, which are mixtures of suspensions and emulsions. These formulations are popular for combining several types of compounds into a single formulation, with stabilization through the choice of inert components and process control parameters.

Efforts to improve the activity of pesticides have been mainly directed toward discovering new compounds that can act as active ingredients of the pesticide. Heretofore, attention has in general not been focused on the optimization of formulations specifically as a route to achieving a surprising increase in the activity of the active pesticidal ingredients in the formulations.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts, in accordance with an embodiment described herein, a chart of knockdown activity of enhanced formulations of a pesticidal blend in the German cockroach.

FIG. 2 depicts, in accordance with an embodiment described herein, a chart of knockdown activity of enhanced formulations of a pesticidal blend in the German cockroach.

FIG. 3 depicts, in accordance with an embodiment described herein, a chart of knockdown activity of enhanced formulations of a pesticidal blend in the German cockroach.

FIG. 4, depicts, in accordance with an embodiment described herein, a chart of knockdown activity of enhanced formulations of a pesticidal blend in Tenebrio molitor.

FIG. 5 depicts, in accordance with an embodiment described herein, a chart of knockdown activity of enhanced formulations of a pesticidal blend in Tenebrio molitor.

FIG. 6 depicts, in accordance with an embodiment described herein, a chart of knockdown activity of enhanced formulations of a pesticidal blend in the German cockroach.

FIG. 7 depicts, in accordance with an embodiment described herein, a chart of knockdown activity of enhanced formulations of a pesticidal blend in the German cockroach.

FIG. 8 depicts, in accordance with an embodiment described herein, a chart of kill activity of enhanced formulations of a pesticidal blend in the German cockroach.

FIG. 9 depicts, in accordance with an embodiment described herein, a chart of knockdown activity of enhanced formulations of a pesticidal blend in the German cockroach.

FIG. 10 depicts, in accordance with an embodiment described herein, a chart of repellency activity against house flies of enhanced formulations of a pesticidal blend.

FIG. 11 depicts, in accordance with an embodiment described herein, a chart of repellency activity against house flies of enhanced formulations of a pesticidal blend.

### SUMMARY

Various embodiments describe a method of controlling a target pest comprising administering an effective amount of a composition comprising at least one active agent and an emulsifying agent, where the active agent comprises two or more oils that act synergistically to control the target pest, the active agent has a first activity against the target pest when applied without the emulsion agent and the composition has a second activity against the target pest; and the second activity is greater than the first activity.

Other embodiments include methods of controlling a pest, comprising forming a microemulsion pesticide formulation comprising the following steps: combining an active ingredient with a microemulsifying agent, where the microemulsifying agent comprises a neutralized potassium salt of fatty acid, and applying an effective amount of the microemulsion pesticide formulation to a location in the vicinity of the pest.

An embodiment provides a method of controlling a target pest, comprising: providing a microemulsion pesticide formulation comprising an active pest control ingredient and a microemulsifying agent, wherein the microemulsifying agent comprises a mixture of unsaturated C12-C26 fatty acids and/or salts thereof and saturated C6-C14 fatty acids and/or salts thereof, and the active pest control ingredient comprises two or more compounds that act synergistically to control the target pest; and applying an effective amount of the microemulsion pesticide formulation to the target pest or to a surface associated with the target pest.

In a further aspect, the active pest control ingredient and the microemulsifying agent act synergistically to control the target pest.

In a further aspect, the active pest-control ingredient comprises a synergistic combination of at least 2 ingredients from an ingredient family, wherein the ingredient family is an Ingredient Family listed in Table 2 below.

In a further aspect, the active pest-control ingredient comprises a synergistic combination of at least 3 ingredients from an ingredient family, wherein the ingredient family is an Ingredient Family listed in Table 2 below having at least 3 ingredients.

In a further aspect, the active pest-control ingredient comprises a synergistic combination of at least 4 ingredients from an ingredient family, wherein the ingredient family is an Ingredient Family listed in Table 2 below having at least 4 ingredients.

In a further aspect, the ingredients are present within a range specified in Range 1 of Table 2.

In a further aspect, the ingredients are present within a range specified in Range 2 of Table 2.

In a further aspect, the ingredients are present within a range specified in Range 3 of Table 2.

In a further aspect, the ingredients are present within a range specified in Range 4 of Table 2.

In a further aspect, the active pest-control ingredient comprises a blend listed in Table 1 below.

In a further aspect, the active pest control ingredient comprises isopropyl myristate, thyme oil or a derivative thereof, and an ingredient selected from the group consisting of wintergreen oil and geraniol.

In a further aspect, the unsaturated fatty acid is selected from the group consisting of oleic acid, ricinoleic acid, linoleic acid, linolenic acid, and mixtures thereof.

In a further aspect, the saturated fatty acid is selected from the group consisting of caprylic acid, capric acid, 2-ethyl hexanoic acid, trimethylhexanoic acid, trimethylnonanoic acid, tetramethylhexanoic acid, and mixtures thereof.

In a further aspect, the microemulsion pesticide formulation additionally comprises a cosolvent.

In a further aspect, the cosolvent is isopropanol.

In a further aspect, the microemulsifying agent comprises a 50:50% by weight mixture of the unsaturated C12-C26 fatty acids and/or salts thereof and the saturated C6-C14 fatty acids and/or salts thereof.

In a further aspect, the unsaturated C12-C26 fatty acids and/or salts thereof comprise oleic acid and the saturated C6-C14 fatty acids and/or salts thereof comprise a 50:50% by weight mixture of capric acid and caprylic acid.

In a further aspect, the unsaturated C12-C26 fatty acids and/or salts thereof comprise soya fatty acids and the saturated C6-C14 fatty acids and/or salts thereof comprise a 50:50% by weight mixture of capric acid and caprylic acid.

In a further aspect, the unsaturated C12-C26 fatty acids and/or salts thereof comprise oleic acid and the saturated C6-C14 fatty acids and/or salts thereof comprise 2-ethyl hexanoic acid.

In a further aspect, the unsaturated C12-C26 fatty acids and/or salts thereof comprise oleic acid and the saturated C6-C14 fatty acids and/or salts thereof comprise trimethylhexanoic acid.

In a further aspect, the unsaturated C12-C26 fatty acids and/or salts thereof comprise a 50:50% by weight mixture of oleic acid and ricinoleic acid and the saturated C6-C14 fatty acids and/or salts thereof comprise a 50:50% by weight mixture of capric acid and caprylic acid.

In a further aspect, the unsaturated C12-C26 fatty acids and/or salts thereof comprise ricinoleic acid and the saturated C6-C14 fatty acids and/or salts thereof comprise a 50:50% by weight mixture of capric acid and caprylic acid.

In a further aspect, the active pest control ingredient comprises geraniol in an amount within a range of 20-40% by weight, isopropyl myristate in an amount within a range of 30-45% by weight, and thyme oil white in an amount within a range of 25-40% by weight.

In a further aspect, the active pest control ingredient comprises approximately 29.9% geraniol, approximately 38.6% isopropyl myristate, and approximately 31.4% thyme oil white.

In a further aspect, the active pest control ingredient comprises isopropyl myristate, a 99:1 mixture of thyme oil white and thyme oil red, and wintergreen oil.

In a further aspect, the active pest control ingredient comprises isopropyl myristate in an amount within a range of 30-40% by weight, wintergreen oil in an amount within a range of 40-50% by weight, and the 99:1 mixture of thyme oil white and thyme oil red in an amount within a range of 15-25% by weight.

In a further aspect, the active pest control ingredient comprises approximately 45.1% wintergreen oil, approximately 34.3% isopropyl myristate, and approximately 20.6% of the mixture of thyme oil white and thyme oil red.

In a further aspect, the target pest is selected from the group consisting of German cockroach, harvester ant, darkling beetle, and mealworm (larval darkling beetle).

In a further aspect, the target pest is selected from the group consisting of American cockroach, Argentine ant, big-headed ant, bed bug, cat flea, crazy ant, diamondback moth, Eastern subterranean termite, flour beetle, German cockroach, ghost ant, honey bee, house cricket, house fly, house spider, millipede, pharaoh ant, red imported fire ant, yellow fever mosquito, lesser grain borer, and brown dog tick.

In a further aspect, the control is selected from the group consisting of kill, knockdown, and repellency.

In a further aspect, the control exhibited by the microemulsion pesticide formulation persists for a first period of time, control exhibited by the active pest control ingredient without the microemulsifying agent persists for a second period of time, and the first period of time is greater than the second period of time. In a further aspect, the first period of time is greater than the second period of time by a factor selected from the group consisting of 20%, 50%, 100%, 200%, 500%, and 1000%.

### DESCRIPTION OF THE INVENTION

The present disclosure relates to certain microemulsion-based formulations of pesticidal blends of essential oils that have been found to enhance the activity of the active essential oil ingredients. Surprisingly, by preparing the pesticide as a microemulsion formulation using a microemulsifying agent mixture of unsaturated C12-C26 fatty acids and/or salts thereof and saturated C6-C14 fatty acids and/or salts thereof, the activity of an ingredient can be greatly enhanced and the efficacy of the pesticide can be greatly improved. In addition to increasing the overall potential potency of the pesticide, enhancing the activity of an active ingredient can also be helpful in reducing the amount of active ingredient that is required for effective pest control. This, in turn, improves the overall safety of the pesticide and can increase the likelihood of a pesticide receiving EPA approval when it becomes developed for commercial application.

Embodiments of the invention are directed to methods of pest control using pest control compositions. Embodiments of the invention employ compositions for controlling pests that include two or more plant essential oils. The plant essential oils, when combined, can have a synergistic effect. Additionally, in some embodiments, these compositions can be made up of generally regarded as safe (GRAS) compounds.

In other embodiments, methods of pest control with long-lasting residual effects are provided in which the microemulsion pesticide formulation described above is sprayed onto a hard surface. In certain embodiments, the control of pests such as insects continues when pests are exposed to the treated surface for a short period of time, and this residual effect lasts for a long period of time. In particular embodiments, pest control is achieved under such circumstances after exposure for only one minute, or 45 seconds, or 30 seconds, or 20 seconds, or 10 seconds. In particular embodiments, the residual effects persist for 3 days, or 5 days, or 7 days or 14 days, or 21 days, a month, two months, or three months or more after the formulation is applied to the surface. In particular embodiments, the residual effects of the microemulsion pesticide formulation persist for a period of time that is 20%, or 50%, or 100%, or 200%, or 500%, or 1000% greater than the period of time in which residual effects are observed when the active pest control ingredient of the formulation is applied without the microemulsifying agent.

In other embodiments, methods of pest control with high levels of repellency are provided in which the microemulsion pesticide formulation described above is sprayed onto a surface, such as for example the skin of an animal, enhanced repellency of pests such as flies, mosquitoes and other biting and nuisance insects is achieved. In a particular embodiment, length of repellency is extended when the microemulsion pesticide formulation is employed, in comparison with the case in which the same blend of active ingredients is employed in a conventional water-based spray. In other preferred embodiments, In other embodiments, methods of pest control with high levels of repellency are provided in which the microemulsion pesticide formulation described above is sprayed in an area, such as an outdoor area, to provide extended repellency of pests such as biting or nuisance insects.

For purposes of simplicity, the term “pest” shall be used in this application. However, it should be understood that the term “pest” can encompass a variety of life forms such as various types of animals including worms and insects, fungi, plants, protists, and monerans. As used in this application the term “insect” can refer not only to insects, but also to mites, spiders, and other arachnids, larvae, and like invertebrates. Also for purposes of this application, the term “pest control” can refer to having a repellant effect, a pesticidal effect, or both. “Repellant effect” is an effect wherein more pests are repelled away from a host or area that has been treated with the composition than a control host or area that has not been treated with the composition. In some embodiments, repellant effect is an effect wherein at least about 75% of pests are repelled away from a host or area that has been treated with the composition. In some embodiments, repellant effect is an effect wherein at least about 90% of pests are repelled away from a host or area that has been treated with the composition.

“Pesticidal effect” is an effect wherein treatment with a composition causes at least about 1% of the pests to die. In this regard, an LC1 to LC100 (lethal concentration) or an LD1 to LD100 (lethal dose) of a composition will cause a pesticidal effect. In some embodiments, the pesticidal effect is an effect wherein treatment with a composition causes at least about 5% of the exposed pests to die.

In some embodiments, the pesticidal effect is an effect wherein treatment with a composition causes at least about 10% of the exposed pests to die. In some embodiments, the pesticidal effect is an effect wherein treatment with a composition causes at least about 25% of the pests to die. In some embodiments the pesticidal effect is an effect wherein treatment with a composition causes at least about 50% of the exposed pests to die. In some embodiments the pesticidal effect is an effect wherein treatment with a composition causes at least about 75% of the exposed pests to die. In some embodiments the pesticidal effect is an effect wherein treatment with a composition causes at least about 90% of the exposed pests to die.

As used herein, the term “bioassay,” refers to a quantitative procedure used to determine the relationship between amount (or dose or concentration) of pesticide administered and the magnitude of response in the living organism.

As used herein, the term “KD” refers to knockdown. “Knockdown” is an effect wherein treatment with a composition causes at least about 1% to display reduced mobility. In some embodiments, the knockdown is an effect wherein treatment with a composition causes at least about 50% of the exposed pests to die. As used herein, the term “KT50” means the knockdown time of 50% of a given population or strain. Similarly, the term “KT90” means the knockdown time of 90% of a given population or strain.

As used herein, the term “C.I.” means confidence interval.

As used herein, the term “Percent Control” refers to a percentage out of 100%.

As used herein, the term “A.I.” means active ingredient.

As used herein, the term “RTU” means Ready-To-Use spray or sprayer.

As used herein, “component of a composition” refers to a compound, or a subset of compounds included in a composition, e.g., the complete composition minus at least one compound.

As disclosed herein, molecular pathways involved in pest behavior and survival were identified, offering molecular targets for the development of pesticides. Although many of the blends described herein were originally developed against insects, they have been found to have surprising antifungal, herbicidal and other properties against other taxa of pests in addition to insects. These effects are enhanced by the formulations.

Embodiments of the invention are directed to pest control methods employing compositions for controlling pests. Certain embodiments employ compositions useful in the present invention that include the following oils, formulations, chemicals, compounds, or mixtures thereof:

Isopropyl myristate. Isopropyl myristate, also known as methylethyl ester or myristic acid isopropyl ester, is an ester of isopropanol and myristate acid.

Wintergreen oil is oil from the shrub genus Gaultheria. Methyl salicylate, the main constituent of the oil, is not present in the plant until formed by enzymatic action from a glycoside within the leaves.

Thyme oil. Thyme oil is a natural product that can be extracted from certain plants, including species from the Labiatae family; for example, thyme oil can be obtained from Thymus vulgaris (also known as, T. ilerdensis, T aestivus, and T. velantianus). Thyme oil red is an unrefined extract, while the refined extract is often termed thyme oil white.

Geraniol. Geraniol, also called rhodinol, is a monoterpenoid and an alcohol. It is the primary part of oil-of-rose and palmarosa oil. It is used in perfumes and as a flavoring. It is also produced by the scent glands of honey bees to help them mark nectar-bearing flowers and locate the entrances to their hives.

The pest control composition employed in the present methods comprises an active ingredient and a formulation ingredient. In an embodiment, the active ingredient includes a blend containing isopropyl myristate, geraniol and thyme oil white. In another embodiment, the active ingredient includes a blend containing isopropyl myristate, wintergreen oil, thyme oil white, and thyme oil red. In another embodiment, expressed as percentage by weight, the pest control composition is a compound that includes 30-40% isopropyl myristate, 40-50% wintergreen oil, and/or 15-25% of a 99:1 mixture of thyme oil white and thyme oil red. In another embodiment, expressed as percentage by weight, the active ingredient is a compound that includes 30-45% isopropyl myristate, 20-40% geraniol, and/or 25-40% thyme oil white.

### Formulation Ingredients

In one embodiment, the formulation ingredient produces a microemulsion that serves to enhance the effectiveness of the active ingredient as a pest control agent. In another embodiment, the formulation ingredient enhances the effectiveness of the active ingredient as a pest control by increasing the surface area of the active ingredient. In another embodiment, the formulation ingredient comprises a mixture of unsaturated C12-C26 fatty acids and/or salts thereof and saturated C6-C14 fatty acids and/or salts thereof.

The unsaturated and saturated fatty acids used in the methods of the present invention are in the form of the free fatty acid and/or salt thereof. Suitable salts are alkali metal salts, such as sodium, and/or potassium; ammonium salts; and/or alkylamine salts, such as isopropylamine, aminomethylpropanol, monoethanolamine, diethanolamine, and/or triethanolamine. Alkali metal, particularly potassium, salts are preferred.

The fatty acid salts are preferably formed in situ by the addition of suitable salt forming material, e.g. base, such as sodium hydroxide, preferably potassium hydroxide, to the fatty acid containing composition. The base is preferably added as a relatively dilute aqueous solution, e.g. at a concentration of 1 to 30%, preferably 5 to 20%, more preferably about 10 to 15% w/w. The addition of base can be used to control the pH of the composition which is preferably in the range from 6 to 9, more preferably 7 to 8.5, particularly 7.2 to 8.2, and especially 7.5 to 8. A surprising improvement in the pest control properties of the composition can be achieved at these pH values.

In one embodiment, the amount of fatty acid salts in the composition is preferably in the range from 50 to 100%, more preferably 90 to 99.9%, particularly 95 to 99.5%, and especially 96 to 99% by weight, based on the total amount of fatty acids and salts thereof in the composition. Correspondingly, the amount of free fatty acids is preferably in the range from 0 to 50%, more preferably 0.1 to 10%, particularly 0.5 to 5%, and especially 1 to 4% by weight, based on the total weight of fatty acids and salts thereof in the composition.

The unsaturated fatty acids and/or salts thereof used in the methods of the present invention comprise, consist essentially of, or consist of, in the range from 12 to 26, preferably 14 to 24, more preferably 16 to 22, particularly 18 to 20, and especially 18 carbon atoms. In one embodiment, greater than 50%, preferably greater than 60%, more preferably greater than 70%, particularly greater than 80%, and especially greater than 90% and up to 100% by weight of the unsaturated fatty acids fall within one or more of the above carbon atom ranges, based on the total weight of unsaturated fatty acids in the composition.

Suitable unsaturated fatty acids are selected from the group consisting of oleic, elaidic, ricinoleic, dodecenoic, tetradecenoic (myristoleic), hexadecenoic (palmitoleic), octadecadienoic (linoleic or linolelaidic), octadecatrienoic (linolenic), eicosenoic (gadoleic), eicosatetraenoic (arachidonic), docosenoic (erucic), docosenoic (brassidic), docosapentaenoic (clupanodonic), eicosapentaenoic, docosahexaenoic, gamma-linolenic, dihomo-gamma-linolenic, arachidonic, acids, and mixtures thereof. Preferred unsaturated fatty acids are selected from the group consisting of oleic, ricinoleic, linoleic, linolenic, acids and mixtures thereof. Particularly preferred unsaturated fatty acids are selected from the group consisting of oleic, ricinoleic, linoleic, acids and mixtures thereof.

The unsaturated fatty acids are preferably monocarboxylic acids and may be linear or branched, and are preferably linear. The unsaturated fatty acids may be in the form of cis and/or trans isomers. Oleic acid is a preferred cis isomer, and elaidic acid a preferred trans isomer. The unsaturated fatty acids may be unsubstituted, or substituted, for example with one or more hydroxyl groups. Ricinoleic acid is a preferred hydroxy acid.

The unsaturated fatty acids may be mono-unsaturated, di-unsaturated or polyunsaturated, i.e. containing one, two or more than two carbon-carbon double bonds respectively. Oleic acid is a preferred mono-unsaturated fatty acid, and linoleic acid is a preferred di-unsaturated fatty acid. In one embodiment, the concentration of (i) mono-unsaturated fatty acids is preferably greater than 10%, more preferably greater than 20%, and particularly in the range from 30 to 90%, by weight, (ii) di-unsaturated fatty acids is preferably greater than 5%, more preferably greater than 10%, and particularly in the range from 15 to 50% by weight, (iii) mono-unsaturated and di-unsaturated fatty acids combined is preferably greater than 75%, more preferably greater than 85%, particularly greater than 90%, and especially in the range from 95 to 100% by weight, and/or (iv) polyunsaturated fatty acids is preferably less than 25%, more preferably less than 15%, particularly less than 5%, and especially in the range from 0 to 3% by weight, all based on the total weight of unsaturated fatty acids in the composition.

The concentration of unsaturated fatty acids and/or salts thereof present in a composition useful in the methods of the present invention is suitably in the range from 10 to 90%, preferably 20 to 80%, more preferably 30 to 70%, particularly 40 to 60%, and especially 45 to 55% by weight, based on the total weight of fatty acids and/or salts thereof in the composition.

In certain compositions useful in an embodiment of the present invention, the unsaturated fatty acids used in various methods of the invention comprise a mixture of unsubstituted fatty acids and hydroxy fatty acids, preferably present at a ratio of 10 to 90%:10 to 90%, more preferably 30 to 70%:30 to 70%, particularly 40 to 60%:40 to 60%, and especially 45 to 55%:45 to 55% by weight, based on the total weight of unsaturated fatty acids in the composition. A particularly preferred combination is a mixture of oleic acid and ricinoleic acid.

The saturated fatty acids and/or salts thereof used in various methods of the present invention comprise, consist essentially of, or consist of, in the range from 6 to 14, preferably 6 to 12, more preferably 8 to 12, and particularly 8 to 10 carbon atoms. In one embodiment, greater than 50%, preferably greater than 60%, more preferably greater than 70%, particularly greater than 80%, and especially greater than 90% and up to 100% by weight of the saturated fatty acids fall within one or more of the above carbon atom ranges, based on the total weight of saturated fatty acids in the composition.

The saturated fatty acids are preferably monocarboxylic acids and may be linear and/or branched, and are preferably linear.

Suitable saturated fatty acids are selected from the group consisting of hexanoic (caproic), octanoic (caprylic), nonanoic, decanoic (capric), undecanoic, dodecanoic (lauric), tridecanoic, tetradecanoic acid (myristic), 2-ethyl hexanoic, trimethylhexanoic, trimethylnonanoic, acids and mixtures thereof. Preferred saturated fatty acids are selected from the group consisting of caprylic, capric, 2-ethyl hexanoic, trimethylhexanoic, trimethylnonanoic, tetramethylhexanoic, acids, and mixtures thereof. Particularly preferred saturated fatty acids are selected from the group consisting of caprylic, capric, 2-ethyl hexanoic, trimethylhexanoic, acids, and mixtures thereof.

The concentration of saturated fatty acids and/or salts thereof present in a composition according to methods of the present invention is suitably in the range from 10 to 90%, preferably 20 to 80%, more preferably 30 to 70%, particularly 40 to 60%, and especially 45 to 55% by weight, based on the total weight of fatty acids and/or salts thereof in the composition.

The ratio by weight of unsaturated fatty acids and/or salts thereof to saturated fatty acids and/or salts thereof in a composition according to various methods of the present invention is preferably in the range from 0.2 to 5:1, more preferably 0.35 to 3:1, particularly 0.5 to 2:1, and especially 0.8 to 1.2:1.

In one embodiment, the mean number of carbon atoms, on a weight basis, present in the unsaturated fatty acids and/or salts is suitably at least 2, preferably at least 4, more preferably in the range from 6 to 12, particularly 7 to 11, and especially 8 to 10 carbon atoms greater than the mean number of carbon atoms present in the saturated fatty acids and/or salts. The mean number of carbon atoms by weight present in the unsaturated fatty acids and/or salts is preferably in the range from 14 to 22, more preferably 16 to 20, particularly 17 to 19, and especially 17.5 to 18.5. The mean number of carbon atoms by weight present in the saturated fatty acids and/or salts is preferably in the range from 6 to 12, more preferably 7 to 11, particularly 8 to 10, and especially 8.5 to 9.5.

The fatty acids and/or salts thereof are suitably present in a composition according to various methods of the present invention in the range from 3 to 50%, preferably 5 to 40%, more preferably 10 to 30%, particularly 15 to 25%, and especially 18 to 22% by weight, based on the total amount of the composition. Alternatively, the amount of fatty acids and/or salts thereof can be expressed in relation to the concentration of the pest control active and therefore are preferably present at a concentration in the range from 50 to 500%, more preferably 100 to 400%, particularly 150 to 350%, and especially 200 to 300% by weight, based on the weight of the pest control active.

Fatty acids, suitable for use herein, can be obtained from natural sources such as, for instance, plant or animal esters (e.g. palm oil, rape seed oil, palm kernel oil, coconut oil, babassu oil, soybean oil, castor oil, tallow, whale or fish oils, grease, lard, and mixtures thereof). Fatty acids derived from plant sources are preferred. Normally purified or distilled unsaturated and/or saturated fatty acids will be employed, but naturally occurring mixtures may also be used where appropriate, e.g. when high in unsaturated fatty acids such as soybean, linseed, sunflower, corn, onagra, and/or borage, oil fatty acids. The fatty acids may also be synthetically prepared, for example as described in “Fatty Acids in Industry”, Ed Robert W Johnson, Earl Fritz, Marcel Dekker Inc, 1989 ISBN 0-8247-7672-0.

The composition for use, in accordance with various embodiments described herein, may also comprise at least one organic carrier oil such as a mineral oil, food oil, or vegetable oil, e.g. fatty acid glyceride, fatty acid ester and fatty alcohol. Examples of suitable relatively non-polar oils include C13-C14 isoparaffin, isohexadecane, paraffinum liquidum (mineral oil), squalane, squalene, hydrogenated polyisobutene, and polydecene; and relatively polar materials include C12-C15 alkyl benzoate, caprylic/capric triglyceride, cetearyl isononanoate, ethylhexyl isostearate, ethylhexyl palmitate, isononyl isononanoate, isopropyl isostearate, isopropyl myristate, isostearyl isostearate, isostearyl neopentanoate, octyldodecanol, pentaerythrityl tetraisostearate, PPG-15 stearyl ether, triethylhexyl triglyceride, dicaprylyl carbonate, ethylhexyl stearate, helianthus annus (sunflower) seed oil, isopropyl palmitate, and octyldodecyl neopentanoate.

The concentration of the carrier oil may vary widely. The amount of the carrier oil is suitably in the range from 0.5 to 40%, preferably 1 to 20%, more preferably 2 to 15%, particularly 3 to 5%, and especially 5 to 10% by weight, based on the total weight of the composition.

The composition may be in any suitable form, but preferably is an emulsion (or suspoemulsion), such as a water-in-oil or oil-in-water, preferably an oil-in-water emulsion. The mixture of fatty acids and/or salts thereof described herein are suitable for use in forming emulsions, i.e. as the, or as part of the, emulsifier system. The emulsifier system comprises, consists essentially of, or consists of a mixture of unsaturated and saturated fatty acids and/or salts thereof as described herein. A particularly surprising feature of the compositions useful in the methods of the present invention is that emulsions can be produced using the fatty acid mixture as the sole component of the emulsifier system, i.e. effectively in the absence of any other surfactant or emulsifier components. By “effective absence” is meant preferably less than 10%, more preferably less than 5%, and particularly less than 2% by weight of any additional anionic, cationic, amphoteric, zwitterionic and/or non-ionic, particularly alkoxylated, surfactants or emulsifiers, based on the total amount of fatty acids and/or salts thereof in the emulsion.

The emulsion may for example be a microemulsion or nanoemulsion, preferably a microemulsion. The emulsion may be bicontinuous or have a mean droplet size over a wide range, preferably in the range from 1 to 1,000 nm, more preferably 5 to 500 nm, and particularly 10 to 100 nm. The emulsion droplet size may be reduced by suitable means, for example by high pressure homogenization.

The oil phase of the emulsion may comprise at least one of the carrier oils described herein. In addition, in one embodiment, the pest control active, preferably one or more terpenoid containing natural oils or plant essential oils as described herein, is present as a component of the oil phase.

The ratio by weight of carrier material to pest control active in the oil phase is preferably in the range from 0.2 to 5:1, more preferably 0.35 to 3:1, particularly 0.5 to 2:1, and especially 0.8 to 1.2:1.

In one embodiment, the oil phase comprises, consists essentially of, or consists of, a blend of isopropyl myristate, geraniol and/or thyme oil white, suitably at a concentration of 30 to 45% by weight isopropyl myristate, 20 to 40% by weight geraniol and/or 25 to 40% by weight thyme oil white, based on the total weight of the oil phase.

In another embodiment, the oil phase comprises, consists essentially of, or consists of, a blend of isopropyl myristate, wintergreen oil and/or thyme oil white and thyme oil red, suitably at a concentration of 30 to 40% by weight isopropyl myristate, 40 to 50% by weight wintergreen oil and/or 15 to 25% by weight of a 99:1 mixture of thyme oil white and thyme oil red, based on the total weight of the oil phase.

The concentration of the oil phase may vary widely. The amount of the oil phase in the emulsion is suitably in the range from 1 to 90%, preferably 3 to 50%, more preferably 5 to 30%, particularly 8 to 20%, and especially 10 to 15% by weight, based on the total weight of the emulsion.

The fatty acids and/or salts thereof are preferably present in an emulsion used in various methods of the present invention in the range from 50 to 300%, more preferably 75 to 250%, particularly 100% to 200%, and especially 100 to 150% by weight, based on the total weight of the oil phase.

The amount of water present in the emulsion is suitably in the range from 10 to 95%, preferably 20 to 85%, more preferably 30 to 80%, particularly 40 to 75%, and especially 50 to 70% by weight, based on the total weight of the emulsion.

The emulsion may also comprise an additional organic cosolvent preferably present at a concentration in the range from 0 to 100%, more preferably 5 to 90%, particularly 20 to 80%, and especially 30 to 50% by weight, based on the total weight of fatty acids and/or salts thereof in the emulsion.

The cosolvent is suitably relatively polar, and preferably is a lower alcohol or ester having a molecular weight of less than 400, more preferably less than 200, and particularly in the range from 40 to 100. Isopropanol and/or ethanol are particularly preferred lower alcohol cosolvents.

The emulsion according to methods of the present invention preferably exhibits stability against emulsion separation, i.e. the emulsion remains homogeneous when stored for extended periods at various temperatures. The emulsion is preferably stable, measured as herein described, at 5° C., more preferably at 25° C., particularly at 40° C., and especially at 50° C., preferably for at least one month, more preferably at least 2 months, and particularly for at least 3 months. The stability at elevated temperatures, i.e. at 40° C. and 50° C., is a particularly important property and can be difficult to achieve.

The emulsion is suitably transparent. By “transparent” is meant having the property of transmitting light without appreciable scattering, so that objects, for example written text, e.g. this patent specification, placed behind the emulsion are entirely visible and can easily be discerned or in the case of written text, read. The amount of light transmitted is, of course, dependent upon the thickness of the emulsion, and in the present context the emulsion can be placed in a clear glass cuvette of 20 mm thickness.

One advantage of the present compositions used in the methods of the present invention is that emulsions can be produced containing only ingredients exempt from EPA registration by virtue of their appearance on the FIFRA 25(b) list or Class 4(a) inert ingredient list making the emulsion completely safe for use, and potentially eligible for classification as an organic pest control agent.

The emulsions used in the methods of the invention may be made by generally conventional emulsification and mixing methods. For example, the unsaturated and saturated fatty acids may be added to (i) the oil phase, to which is then added the aqueous phase, (ii) both the combined oil and aqueous phases, (iii) the aqueous phase, to which is then added the oil phase, or (iv) the saturated fatty acids are added to the aqueous phase and the unsaturated fatty acids are added to the oil phase, the two phases being subsequently combined. Method (i) is preferred. The salt forming moiety or base is suitably incorporated in the aqueous phase prior to mixing with the oil phase. Since the combination of the base with the fatty acids is exothermic, heating is generally not required to form the emulsion. In all of these methods, the resulting mixture can form a stable emulsion, particularly when the base is introduced as part of the aqueous phase. Sufficient base can be added to obtain the required pH. The preferred embodiment forms a stable transparent microemulsion. The emulsion can be formed in one process vessel, through a single contiguous series of steps.

The emulsions are preferably formed at low or ambient temperature and/or at low to moderate shear. Low temperature or cold processing is particularly advantageous where volatile oils are being used which could be lost or degraded at high temperatures, or which may be subject to increased risk of fire or explosion. It is a feature of the compositions used in the methods of the present invention that stable emulsions can be produced at low temperature, and with suitable low viscosity at these temperatures, to allow low shear mixing.

By the term “low temperature” is meant a temperature of not more than 60° C., preferably not more than 50° C. and especially not more than 40° C. Additionally, the term “low temperature” means a temperature of greater than 0° C., preferably at least 10° C., and especially at least 15° C. Preferred temperatures are in the range from 15° C. to 50° C., more preferably 20° C. to 40° C.

By the term “low shear” is meant a shear rate of not more than 5000 s⁻¹. Additionally, the term “low shear” means a shear rate of greater than 10 s⁻¹, preferably at least 50 s⁻¹.

The emulsions can also be made by inverse emulsification methods, whereby the fatty acid mixture is added to the oil phase, the aqueous phase is then added and mixed into the oil phase to form a water-in-oil emulsion. Aqueous phase addition, including base, is continued until the system inverts to form an oil-in-water emulsion. Plainly a substantial amount of aqueous phase and/or the inclusion of sufficient base to achieve a final pH of at least 7 will generally be needed to effect complete inversion and so this method is not likely to be used for very high oil phase content emulsions.

The emulsions described herein may be used directly to control pests, or the emulsion may be used as a pre-concentrate enabling dilution with water, for example up to 15 times, preferably up to 10 times, particularly in the range from 1 to 7, and especially 3 to 5 times. A feature of the compositions used in the methods of the present invention is that stable, transparent emulsions can be obtained after such a dilution, giving increased flexibility to the end-use formulator.

The emulsion described herein is particularly suitable for use as a sprayable product. Such emulsions suitably have a low shear viscosity of up to 2000, preferably up to 1000, more preferably in the range from 1 to 500, particularly 1 to 300, and especially 1 to 100 mPa·s. The most preferred microemulsion formulations generally display Newtonian (non-shear thinning) behavior although bicontinuous microemulsion systems are shear-thinning.

In this specification the following test methods have been used:

(i) Viscosity was measured with a Brookfield DV II+ viscometer using an appropriate spindle (LV1, LV2, LV3, or LV4—depending on the viscosity of the emulsion being tested) at 6 rpm (0.1 Hz), 1 day after making the emulsions and results are quoted in mPa·s.

(ii) Stability was assessed by observing the emulsions after storage at ambient temperature (20 to 25° C.), cold at 5° C. or under elevated temperature storage at 40° C. and 50° C. The composition is stable if the emulsion remains transparent and no visible separation of the emulsion occurs.

A particular advantage of the pest control formulations of the present disclosure is that they comprise only ingredients that are described in numerous lists of permissible or exempt ingredients maintained by the Federal government. Compositions such as those used in the present methods that contain only such ingredients face much lower regulatory barriers and consequently are much easier to introduce into the marketplace. These lists include, for example, those set forth in Environmental Protection Agency regulations, such as 40 C.F.R. §180.950, as well as those described in the Federal Insecticide, Fungicide and Rodenticide Act (FIFRA)'s §25(b) and 4(a) Food-Use Non-Food Use listings for pesticide products.

Preferred compositions useful in embodiments begin with a primary blend. A primary blend is preferably a synergistic combination containing two or more active ingredients and, optionally, additional ingredients. The primary blend can then be combined with other ingredients to produce a formulation. Accordingly, where concentrations, concentration ranges, or amounts, are given herein, such quantities typically are in reference to a primary blend or blends. Thus, when a primary blend is further modified by addition of other ingredients to produce a formulation, the concentrations of the active ingredients are reduced proportional to the presence of other ingredients in the formulation.

In another embodiment, the present invention provides a method of controlling pests by administering the compounds described herein. The compositions used in the methods of the present invention can be used to control pests by either treating a host directly, or treating an area in which the host will be located. For example, the host can be treated directly by using a cream or spray formulation, which can be applied externally or topically, e.g., to the skin of a human. A composition can be applied to the host, for example, in the case of a human, using formulations of a variety of personal products or cosmetics for use on the skin or hair. For example, any of the following can be used: fragrances, colorants, pigments, dyes, colognes, skin creams, skin lotions, deodorants, talcs, bath oils, soaps, shampoos, hair conditioners, styling agents, and the like.

In the case of an animal, human or non-human, the host can also be treated directly by using a formulation of a composition that is delivered orally. For example, a composition can be enclosed within a liquid capsule and ingested.

An area can be treated with a composition in accordance with a method of the present invention, for example, by using a spray formulation, such as an aerosol or a pump spray, or a burning formulation, such as a candle or a piece of incense containing the composition. Of course, various treatment methods can be used without departing from the spirit and scope of the present invention. For example, compositions can be comprised in household products such as: air fresheners (including heated air fresheners in which insect repellent substances are released upon heating, e.g., electrically, or by burning); hard surface cleaners; or laundry products (e.g., laundry detergent-containing compositions, conditioners).

Further discussion of various approaches to screening, preparing, evaluating, and using pest control formulations are also disclosed in the following applications, each of which is incorporated by reference in its entirety: U.S. patent application Ser. No. 10/832,022, entitled COMPOSITIONS AND METHODS FOR CONTROLLING INSECTS; U.S. patent application Ser. No. 11/086,615, entitled COMPOSITIONS AND METHODS FOR CONTROLLING INSECTS RELATED TO THE OCTOPAMINE RECEPTOR; .U.S. patent application Ser. No. 11/365,426, entitled COMPOSITIONS AND METHODS FOR CONTROLLING INSECTS INVOLVING THE TYRAMINE RECEPTOR; U.S. patent application Ser. No. 11/879,567, U.S. patent application Ser. No. 11/769,654, U.S. patent application Ser. No. 12/009,220, entitled PEST CONTROL COMPOSITIONS AND METHODS, and International Patent Application No. PCT/US08/03722.

One skilled in the art will recognize many methods and materials similar or equivalent to those described herein, which could be used in the practice of the present invention. Indeed, the present invention is in no way limited to the methods and materials described.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art can develop equivalent means or reactants without the exercise of inventive capacity and without departing from the scope of the invention.

As readily understood by one of skill in the art, there are any number of additional blends, compounds and ingredients can also be used in conjunction with the various embodiments described herein. Thus, in addition to or in substitution of the specific ingredients and/or formulations described in the specification above and the following examples, there are additional combinations of blends and compounds that are within the scope of compounds claimed herein. For example, the methods of the present invention can employ various pest control formulations that contain, as a pest control active ingredient, a blend selected from Table 1 (below).

TABLE 1
BLENDS

| | | CAS Registry | | |
|---|---|---|---|---|
| | Compounds | Number | low % | high % |
| Blend 1 | LFO | | 4 | 30 |
| | D-Limonene | 5989-27-5 | 8 | 99 |
| | Thyme Oil White | 8007-46-3 | 0.1 | 20 |
| | Blend 65 | | 8 | 99 |
| Blend 2 | D-Limonene | 5989-27-5 | 9 | 99 |
| | Thyme Oil White | 8007-46-3 | 0.1 | 20 |
| | Linalool Coeur | 78-70-6 | 0.1 | 4 |
| | Tetrahydrolinalool | 78-69-3 | 0.1 | 5 |
| | Vanillin | 121-33-5 | 0.06 | 0.3 |
| | Isopropyl myristate | 110-27-0 | 0.1 | 5 |
| | Piperonal (aldehyde) [Heliotropine] | 120-57-0 | 0.1 | 5 |
| | Blend 66 | | 8 | 99 |
| | Geraniol Fine FCC | 106-24-1 | 0.1 | 4 |
| | Triethyl Citrate | 77-93-0 | 0.1 | 5 |
| Blend 3 | D-Limonene | 5989-27-5 | 45 | 99 |
| | Thyme Oil White | 8007-46-3 | 0.1 | 10 |
| | Blend 66 | | 5 | 30 |
| | Blend 63 | | 0.1 | 10 |
| Blend 4 | LFO | | 30 | 99 |
| | BSO | 977017-84-7 | 15 | 99 |
| Blend 5 | BSO | 977017-84-7 | 15 | 99 |
| | Linalool Coeur | 78-70-6 | 6 | 40 |
| | Tetrahydrolinalool | 78-69-3 | 8 | 45 |
| | Vanillin | 121-33-5 | 0.1 | 5 |
| | Isopropyl myristate | 110-27-0 | 10 | 55 |
| | Piperonal (aldehyde) [Heliotropine] | 120-57-0 | 0.1 | 20 |
| | Geraniol Fine FCC | 106-24-1 | 0.1 | 25 |
| Blend 6 | D-Limonene | 5989-27-5 | 0.1 | 25 |
| | BSO | 977017-84-7 | 15 | 85 |
| | Linalool Coeur | 78-70-6 | 0.1 | 25 |
| | Tetrahydrolinalool | 78-69-3 | 0.1 | 25 |
| | Vanillin | 121-33-5 | 0.1 | 3 |
| | Isopropyl myristate | 110-27-0 | 0.1 | 30 |
| | Piperonal (aldehyde) [Heliotropine] | 120-57-0 | 0.1 | 10 |
| | Geraniol Fine FCC | 106-24-1 | 0.1 | 15 |
| | Methyl Salicylate 98% Nat | 119-36-8 | 8 | 70 |
| Blend 7 | Thyme Oil White | 8007-46-3 | 15 | 90 |
| | Wintergreen Oil | 68917-75-9 | 15 | 99 |
| | Vanillin | 121-33-5 | 0.1 | 4 |
| | Isopropyl myristate | 110-27-0 | 20 | 99 |
| Blend 8 | D-Limonene | 5989-27-5 | 20 | 99 |
| | Thyme Oil White | 8007-46-3 | 0.1 | 25 |
| | Wintergreen Oil | 68917-75-9 | 25 | 99 |
| Blend 9 | LFO | | 6 | 40 |
| | D-Limonene | 5989-27-5 | 25 | 99 |
| | Thyme Oil White | 8007-46-3 | 5 | 30 |
| | Linalool Coeur | 78-70-6 | 0.1 | 3 |
| | Citral | 5392-40-5 | 0.1 | 20 |
| | gamma-terpinene | 99-85-4 | 0.1 | 20 |
| | Alpha-Pinene, 98% | 80-56-8 | 0.1 | 5 |
| | alpha-Terpineol | 98-55-5 | 0.1 | 15 |
| | Terpinolene | 586-62-9 | 0.1 | 15 |
| | Para-Cymene | 99-87-6 | 0.1 | 5 |
| | Linalyl Acetate | 115-95-7 | 0.1 | 6 |
| | Beta Pinene | 127-91-3 | 0.1 | 6 |
| | Camphor Dextro | 464-49-3 | 0.05 | 0.3 |
| | Terpinene 4 OL | 562-74-3 | 0.05 | 0.3 |
| | Alpha Terpinene | 99-86-5 | 0.1 | 6 |
| | Borneol L | 507-70-0 | 0.1 | 3 |
| | Camphene | 79-92-5 | 0.1 | 2 |
| | Decanal | 112-31-2 | 0.06 | 0.3 |
| | Dodecanal | 112-54-9 | 0.06 | 0.3 |
| | Fenchol Alpha | 512-13-0 | 0.005 | 0.1 |
| | Geranyl Acetate | 105-87-3 | 0.06 | 0.3 |
| | Isoborneol | 124-76-5 | 0.08 | 1 |
| | 2-Methyl 1,3-cyclohexadiene | 30640-46-1, 1888- | 0.08 | 1 |
| | | 90-0 | | |
| | Myrcene | 123-35-3 | 0.1 | 3 |
| | Nonanal | 124-19-6 | 0.005 | 0.08 |
| | Octanal | 124-13-0 | 0.005 | 0.2 |
| | Tocopherol Gamma (TENOX ®) | 54-28-4 | 0.005 | 0.08 |
| Blend 10 | D-Limonene | 5989-27-5 | 0.1 | 25 |
| | Thyme Oil White | 8007-46-3 | 0.1 | 25 |
| | Blend 65 | | 40 | 99 |
| | Linalool Coeur | 78-70-6 | 0.1 | 6 |
| | Tetrahydrolinalool | 78-69-3 | 0.1 | 8 |
| | Vanillin | 121-33-5 | 0.08 | 0.6 |
| | Isopropyl myristate | 110-27-0 | 0.1 | 8 |
| | Piperonal (aldehyde) [Heliotropine] | 120-57-0 | 0.1 | 8 |
| | Geraniol Fine FCC | 106-24-1 | 0.1 | 4 |
| | Triethyl Citrate | 77-93-0 | 0.1 | 8 |
| Blend 11 | Thyme Oil White | 8007-46-3 | 3 | 65 |
| | Wintergreen Oil | 68917-75-9 | 15 | 99 |
| | Isopropyl myristate | 110-27-0 | 20 | 99 |
| Blend 12 | D-Limonene | 5989-27-5 | 5 | 30 |
| | Linalool Coeur | 78-70-6 | 8 | 40 |
| | Tetrahydrolinalool | 78-69-3 | 15 | 99 |
| | Vanillin | 121-33-5 | 0.1 | 8 |
| | Isopropyl myristate | 110-27-0 | 15 | 85 |
| | Piperonal (aldehyde)[Heliotropine] | 120-57-0 | 5 | 30 |
| | Geraniol Fine FCC | 106-24-1 | 5 | 30 |
| Blend 13 | D-Limonene | 5989-27-5 | 5 | 30 |
| | Geraniol Fine FCC | 106-24-1 | 5 | 30 |
| | Blend 62 | | 50 | 99 |
| Blend 14 | D-Limonene | 5989-27-5 | 5 | 30 |
| | Blend 72 | | 55 | 99 |
| Blend 15 | D-Limonene | 5989-27-5 | 5 | 30 |
| | Linalool Coeur | 78-70-6 | 10 | 55 |
| | Tetrahydrolinalool | 78-69-3 | 10 | 65 |
| | Vanillin | 121-33-5 | 0.1 | 4 |
| | Isopropyl myristate | 110-27-0 | 10 | 60 |
| | Piperonal (aldehyde)[Heliotropine] | 120-57-0 | 10 | 65 |
| | Piperonyl Alcohol | 495-76-1 | 0.1 | 25 |
| Blend 16 | D-Limonene | 5989-27-5 | 5 | 30 |
| | BSO | 977017-84-7 | 15 | 80 |
| | Linalool Coeur | 78-70-6 | 5 | 30 |
| | Tetrahydrolinalool | 78-69-3 | 6 | 35 |
| | Vanillin | 121-33-5 | 0.1 | 4 |
| | Mineral Oil White (USP) | 8042-47-5 | 8 | 45 |
| | Isopropyl myristate | 110-27-0 | 8 | 45 |
| | Piperonal (aldehyde)[Heliotropine] | 120-57-0 | 0.1 | 15 |
| | Geraniol Fine FCC | 106-24-1 | 0.1 | 20 |
| Blend 17 | D-Limonene | 5989-27-5 | 10 | 99 |
| | Linalool Coeur | 78-70-6 | 0.1 | 10 |
| | Tetrahydrolinalool | 78-69-3 | 0.1 | 10 |
| | Vanillin | 121-33-5 | 0.08 | 0.6 |
| | Isopropyl myristate | 110-27-0 | 0.1 | 10 |
| | Piperonal (aldehyde)[Heliotropine] | 120-57-0 | 0.1 | 10 |
| | Piperonyl Alcohol | 495-76-1 | 0.1 | 5 |
| | Blend 66 | | 10 | 99 |
| Blend 18 | Linalool Coeur | 78-70-6 | 0.1 | 15 |
| | Tetrahydrolinalool | 78-69-3 | 0.1 | 20 |
| | Vanillin | 121-33-5 | 0.1 | 2 |
| | Isopropyl myristate | 110-27-0 | 0.1 | 20 |
| | Piperonal (aldehyde)[Heliotropine] | 120-57-0 | 0.1 | 20 |
| | Piperonyl Alcohol | 495-76-1 | 0.1 | 10 |
| | Blend 66 | | 40 | 99 |
| Blend 19 | LFO | | 20 | 99 |
| | D-Limonene | 5989-27-5 | 15 | 85 |
| | Thyme Oil White | 8007-46-3 | 15 | 90 |
| Blend 20 | D-Limonene | 5989-27-5 | 15 | 85 |
| | Thyme Oil White | 8007-46-3 | 15 | 95 |
| | Blend 63 | | 20 | 99 |
| Blend 21 | D-Limonene | 5989-27-5 | 15 | 85 |
| | Thyme Oil White | 8007-46-3 | 15 | 90 |
| | Linalool Coeur | 78-70-6 | 0.1 | 15 |
| | Tetrahydrolinalool | 78-69-3 | 0.1 | 25 |
| | Vanillin | 121-33-5 | 0.1 | 2 |
| | Isopropyl myristate | 110-27-0 | 0.1 | 25 |
| | Piperonal (aldehyde)[Heliotropine] | 120-57-0 | 0.1 | 25 |
| | Geraniol Fine FCC | 106-24-1 | 0.1 | 10 |
| | Triethyl Citrate | 77-93-0 | 0.1 | 25 |
| Blend 22 | Phenyl Ethyl Propionate | | 20 | 99 |
| | Methyl Salicylate | | 20 | 99 |
| | Blend 43 | | 15 | 85 |
| Blend 23 | D-Limonene | 5989-27-5 | 0.1 | 10 |
| | Thyme Oil White | 8007-46-3 | 0.1 | 15 |
| | Benzyl Alcohol | 100-51-6 | 8 | 50 |
| | Isopar M | 64742-47-8 | 10 | 65 |
| | Water | 7732-18-5 | 25 | 99 |
| | Blend 63 | | 0.1 | 15 |
| | Stock 10% SLS Solution | | 0.1 | 10 |
| Blend 24 | D-Limonene | 5989-27-5 | 0.1 | 10 |
| | Thyme Oil White | 8007-46-3 | 0.1 | 15 |
| | Linalool Coeur | 78-70-6 | 0.1 | 3 |
| | Tetrahydrolinalool | 78-69-3 | 0.1 | 4 |
| | Vanillin | 121-33-5 | 0.05 | 0.3 |
| | Isopropyl myristate | 110-27-0 | 0.1 | 4 |
| | Piperonal (aldehyde)[Heliotropine] | 120-57-0 | 0.1 | 4 |
| | Geraniol Fine FCC | 106-24-1 | 0.1 | 2 |
| | Triethyl Citrate | 77-93-0 | 0.1 | 4 |
| | Benzyl Alcohol | 100-51-6 | 8 | 50 |
| | Isopar M | 64742-47-8 | 10 | 65 |
| | Water | 7732-18-5 | 25 | 99 |
| | Stock 10% SLS Solution | | 0.1 | 10 |
| Blend 25 | D-Limonene | 5989-27-5 | 6 | 40 |
| | Thyme Oil White | 8007-46-3 | 8 | 45 |
| | Benzyl Alcohol | 100-51-6 | 30 | 99 |
| | Blend 63 | | 10 | 55 |
| Blend 26 | LFO | | 0.1 | 25 |
| | D-Limonene | 5989-27-5 | 8 | 99 |
| | Thyme Oil White | 8007-46-3 | 0.1 | 20 |
| | Blend 66 | | 8 | 99 |
| Blend 27 | Linalool Coeur | 78-70-6 | 0.1 | 20 |
| | Soy Bean Oil | 8016-70-4 | 10 | 70 |
| | Thymol (crystal) | 89-83-8 | 20 | 99 |
| | Alpha-Pinene, 98% | 80-56-8 | 0.1 | 10 |
| | Para-Cymene | 99-87-6 | 15 | 85 |
| Blend 28 | Linalool Coeur | 78-70-6 | 0.1 | 25 |
| | Thymol (crystal) | 89-83-8 | 25 | 99 |
| | Alpha-Pinene, 98% | 80-56-8 | 0.1 | 15 |
| | Para-Cymene | 99-87-6 | 20 | 99 |
| Blend 29 | D-Limonene | 5989-27-5 | 0.1 | 25 |
| | Thyme Oil White | 8007-46-3 | 0.1 | 30 |
| | Blend 65 | | 35 | 99 |
| | Linalool Coeur | 78-70-6 | 0.1 | 8 |
| | Tetrahydrolinalool | 78-69-3 | 0.1 | 10 |
| | Vanillin | 121-33-5 | 0.08 | 1 |
| | Isopropyl myristate | 110-27-0 | 0.1 | 10 |
| | Piperonal (aldehyde)[Heliotropine] | 120-57-0 | 0.1 | 5 |
| | Geraniol Fine FCC | 106-24-1 | 0.1 | 5 |
| Blend 30 | D-Limonene | 5989-27-5 | 15 | 85 |
| | Thyme Oil White | 8007-46-3 | 0.1 | 15 |
| | Methyl Salicylate | | 35 | 99 |
| Blend 31 | Thyme Oil White | 8007-46-3 | 0.1 | 5 |
| | Wintergreen Oil | 68917-75-9 | 0.1 | 8 |
| | Isopropyl myristate | 110-27-0 | 0.1 | 6 |
| | Span 80 | 1338-43-8 | 0.1 | 2 |
| | Isopar M | 64742-47-8 | 8 | 45 |
| | Water | 7732-18-5 | 40 | 99 |
| | Bifenthrin | 83657-04-3 | 0.005 | 0.2 |
| Blend 32 | Castor Oil hydrogenated—PEO40 | | 30 | 99 |
| | Lemon Grass Oil—India | | 10 | 70 |
| | Blend 1 | | 10 | 70 |
| Blend 33 | LFO | | 8 | 50 |
| | D-Limonene | 5989-27-5 | 35 | 99 |
| | Thyme Oil White | 8007-46-3 | 6 | 35 |
| | BSO | 977017-84-7 | 0.1 | 15 |
| Blend 34 | D-Limonene | 5989-27-5 | 0.1 | 25 |
| | Thyme Oil White | 8007-46-3 | 0.1 | 30 |
| | Blend 65 | | 30 | 99 |
| | Linalool Coeur | 78-70-6 | 0.1 | 5 |
| | Tetrahydrolinalool | 78-69-3 | 0.1 | 8 |
| | Vanillin | 121-33-5 | 0.06 | 0.5 |
| | Isopropyl myristate | 110-27-0 | 0.1 | 8 |
| | Piperonal (aldehyde)[Heliotropine] | 120-57-0 | 0.1 | 8 |
| | Geraniol Fine FCC | 106-24-1 | 0.1 | 4 |
| | Triethyl Citrate | 77-93-0 | 0.1 | 8 |
| | Isopar M | 64742-47-8 | 8 | 40 |
| Blend 35 | Isopropyl myristate | 110-27-0 | 20 | 99 |
| | Wintergreen Oil | | 25 | 99 |
| | Blend 68 | | 10 | 60 |
| Blend 36 | Wintergreen Oil | 68917-75-9 | 25 | 99 |
| | Isopropyl myristate | 110-27-0 | 20 | 99 |
| | Thyme Oil Red | 8007-46-3 | 10 | 60 |
| Blend 37 | Wintergreen Oil | 68917-75-9 | 25 | 99 |
| | Vanillin | 121-33-5 | 0.06 | 0.3 |
| | Isopropyl myristate | 110-27-0 | 20 | 99 |
| | Thyme Oil Red | 8007-46-3 | 10 | 60 |
| Blend 38 | Thyme Oil White | 8007-46-3 | 15 | 95 |
| | Isopropyl myristate | 110-27-0 | 25 | 99 |
| | Geraniol Fine FCC | 106-24-1 | 10 | 70 |
| Blend 39 | Isopropyl myristate | 110-27-0 | 25 | 99 |
| | Geraniol Fine FCC | 106-24-1 | 10 | 70 |
| | Thyme Oil White | 8007-46-3 | 20 | 99 |
| Blend 40 | Orange Terpenes | 68647-72-3 | 0.1 | 25 |
| | Blend 68 | | 0.1 | 30 |
| | Blend 69 | | 35 | 99 |
| | Blend 71 | | 6 | 40 |
| Blend 41 | Linalool Coeur | 78-70-6 | 10 | 70 |
| | Amyl Butyrate | 540-18-1 | 10 | 70 |
| | Anise Star Oil | | 30 | 99 |
| Blend 42 | Thyme Oil White | 8007-46-3 | 15 | 75 |
| | Amyl Butyrate | 540-18-1 | 10 | 70 |
| | Anise Star Oil | | 30 | 99 |
| Blend 43 | Tetrahydrolinalool | 78-69-3 | 10 | 70 |
| | Vanillin | 121-33-5 | 0.1 | 4 |
| | Hercolyn D | 8050-15-5 | 0.1 | 15 |
| | Isopropyl myristate | 110-27-0 | 8 | 45 |
| | Piperonal (aldehyde)[Heliotropine] | 120-57-0 | 0.1 | 25 |
| | Ethyl Linalool | 10339-55-6 | 10 | 70 |
| | Hedione | 24851-98-7 | 0.1 | 20 |
| | Triethyl Citrate | 77-93-0 | 5 | 30 |
| | Dipropylene glycol (DPG) | 246-770-3 | 0.1 | 25 |
| Blend 44 | Blend 63 | | 25 | 99 |
| | Thyme Oil White | | 30 | 99 |
| Blend 45 | Linalool coeur | 78-70-6 | 0.1 | 20 |
| | Tetrahydrolinalool | 78-69-3 | 0.1 | 25 |
| | Vanillin | 121-33-5 | 0.1 | 2 |
| | Isopropyl myristate | 110-27-0 | 0.1 | 30 |
| | Piperonal (aldehyde)[Heliotropine] | 120-57-0 | 0.1 | 30 |
| | Geraniol Fine FCC | 106-24-1 | 0.1 | 15 |
| | Triethyl citrate | 77-93-0 | 0.1 | 30 |
| | Thyme Oil White | | 30 | 99 |
| Blend 46 | Phenyl Ethyl Propionate | | 10 | 55 |
| | Benzyl Alcohol | 100-51-6 | 30 | 99 |
| | Methyl Salicylate | | 10 | 55 |
| | Blend 43 | | 8 | 40 |
| Blend 47 | Thyme Oil White | 8007-46-3 | 15 | 75 |
| | Amyl Butyrate | 540-18-1 | 10 | 70 |
| | Anise Star Oil | | 30 | 99 |
| | Genistein | | 0.005 | 0.1 |
| Blend 48 | Linalool coeur | 78-70-6 | 10 | 70 |
| | Amyl Butyrate | 540-18-1 | 10 | 70 |
| | Anise Star Oil | | 30 | 99 |
| | Thyme Oil White | | 0.005 | 0.1 |
| Blend 49 | LFO | | 10 | 70 |
| | BSO | 977017-84-7 | 10 | 70 |
| | Benzyl Alcohol | 100-51-6 | 30 | 99 |
| Blend 50 | Isopropyl myristate | 110-27-0 | 10 | 70 |
| | Wintergreen oil | | 15 | 90 |
| | Thyme oil white | | 8 | 40 |
| | Myristicin | | 15 | 99 |
| Blend 51 | Isopropyl myristate | 110-27-0 | 15 | 80 |
| | Wintergreen oil | | 15 | 95 |
| | Isopropyl alcohol | 67-63-0 | 0.1 | 10 |
| | Thyme oil white | | 8 | 40 |
| | Myristicin | | 15 | 75 |
| Blend 52 | Isopropyl myristate | 110-27-0 | 20 | 99 |
| | Wintergreen oil | | 25 | 99 |
| | Thyme oil white | | 10 | 60 |
| | Genistein | | 0.001 | 0.1 |
| Blend 53 | Isopropyl myristate | 110-27-0 | 20 | 99 |
| | Wintergreen oil | | 20 | 99 |
| | Isopropyl alcohol | 67-63-0 | 5 | 30 |
| | Thyme oil white | | 8 | 50 |
| | Genistein | | 0.001 | 0.1 |
| Blend 54 | Isopropyl myristate | 110-27-0 | 10 | 70 |
| | Wintergreen oil | | 15 | 90 |
| | Thyme oil white | | 8 | 40 |
| | Genistein | | 0.001 | 0.1 |
| | Myristicin | | 15 | 99 |
| Blend 55 | Mineral oil white | 8042-47-5 | 20 | 99 |
| | Wintergreen oil | | 25 | 99 |
| | Thyme oil white | | 10 | 60 |
| Blend 56 | Mineral oil white | 8042-47-5 | 10 | 50 |
| | Wintergreen oil | | 10 | 65 |
| | Thyme oil white | | 5 | 30 |
| | Benzaldehyde | | 30 | 99 |
| Blend 57 | Mineral oil white | 8042-47-5 | 10 | 55 |
| | Wintergreen oil | | 10 | 65 |
| | Thyme oil white | | 5 | 30 |
| | Genistein | | 15 | 75 |
| | Benzaldehyde | | 15 | 80 |
| Blend 58 | Linalool Coeur | 78-70-6 | 4 | 65 |
| | Thymol (crystal) | 89-83-8 | 20 | 99 |
| | Alpha-Pinene, 98% | 80-56-8 | 1 | 10 |
| | Para-Cymene | 99-87-6 | 1 | 55 |
| | Trans-Anethole | 4180-23-8 | 10 | 55 |
| Blend 59 | Linalool Coeur | 78-70-6 | 0.1 | 30 |
| | Thymol (crystal) | 89-83-8 | 25 | 99 |
| | Alpha-Pinene, 98% | 80-56-8 | 0.1 | 30 |
| | Para-Cymene | 99-87-6 | 15 | 99 |
| Blend 60 | Soy Bean Oil | 8016-70-4 | 15 | 75 |
| | Alpha-Pinene, 98% | 80-56-8 | 0.1 | 10 |
| | Para-Cymene | 99-87-6 | 15 | 85 |
| | Linalyl Acetate | 115-95-7 | 0.1 | 20 |
| | Thymol acetate | 528-79-0 | 20 | 99 |
| Blend 61 | Alpha-Pinene, 98% | 80-56-8 | 0.1 | 30 |
| | Para-Cymene | 99-87-6 | 10 | 55 |
| | Linalyl Acetate | 115-95-7 | 10 | 70 |
| | Thymol acetate | 528-79-0 | 30 | 99 |
| Blend 62 | Linalool Coeur | 78-70-6 | 10 | 60 |
| | Tetrahydrolinalool | 78-69-3 | 10 | 70 |
| | Vanillin | 121-33-5 | 0.1 | 8 |
| | Isopropyl myristate | 110-27-0 | 15 | 90 |
| | Piperonal (aldehyde)[Heliotropine] | 120-57-0 | 5 | 30 |
| | Geraniol Fine FCC | 106-24-1 | 8 | 40 |
| Blend 63 | Linalool Coeur | 78-70-6 | 8 | 40 |
| | Tetrahydrolinalool | 78-69-3 | 10 | 55 |
| | Vanillin | 121-33-5 | 0.1 | 4 |
| | Isopropyl myristate | 110-27-0 | 10 | 55 |
| | Piperonal (aldehyde)[Heliotropine] | 120-57-0 | 10 | 55 |
| | Geraniol Fine FCC | 106-24-1 | 5 | 30 |
| | Triethyl Citrate | 77-93-0 | 10 | 55 |
| Blend 64 | Linalool Coeur | 78-70-6 | 10 | 60 |
| | Tetrahydrolinalool | 78-69-3 | 10 | 70 |
| | Vanillin | 121-33-5 | 0.1 | 4 |
| | Isopropyl myristate | 110-27-0 | 10 | 70 |
| | Piperonal (aldehyde)[Heliotropine] | 120-57-0 | 10 | 70 |
| | Piperonyl Alcohol | 495-76-1 | 0.1 | 30 |
| Blend 65 | D-Limonene | 5989-27-5 | 25 | 99 |
| | Linalool Coeur | 78-70-6 | 0.1 | 4 |
| | Citral | 5392-40-5 | 5 | 30 |
| | gamma-terpinene | 99-85-4 | 5 | 30 |
| | Alpha-Pinene, 98% | 80-56-8 | 0.1 | 6 |
| | alpha-Terpineol | 98-55-5 | 0.1 | 20 |
| | Terpinolene | 586-62-9 | 0.1 | 20 |
| | Para-Cymene | 99-87-6 | 0.1 | 5 |
| | Linalyl Acetate | 115-95-7 | 0.1 | 8 |
| | Beta Pinene | 127-91-3 | 0.1 | 10 |
| | Camphor Dextro | 464-49-3 | 0.06 | 0.3 |
| | Terpinene 4 OL | 562-74-3 | 0.06 | 0.3 |
| | Alpha Terpinene | 99-86-5 | 0.1 | 10 |
| | Borneol L | 507-70-0 | 0.1 | 5 |
| | Camphene | 79-92-5 | 0.1 | 2 |
| | Decanal | 112-31-2 | 0.08 | 0.6 |
| | Dodecanal | 112-54-9 | 0.06 | 0.3 |
| | Fenchol Alpha | 512-13-0 | 0.001 | 0.1 |
| | Geranyl Acetate | 105-87-3 | 0.08 | 0.6 |
| | Isoborneol | 124-76-5 | 0.1 | 2 |
| | 2-Methyl 1,3-cyclohexadiene | 30640-46-1, 1888- | 0.1 | 2 |
| | | 90-0 | | |
| | Myrcene | 123-35-3 | 0.1 | 4 |
| | Nonanal | 124-19-6 | 0.001 | 0.1 |
| | Octanal | 124-13-0 | 0.05 | 0.2 |
| | Tocopherol Gamma (TENOX ®) | 54-28-4 | 0.001 | 0.1 |
| Blend 66 | D-Limonene | 5989-27-5 | 30 | 99 |
| | Linalool Coeur | 78-70-6 | 0.1 | 5 |
| | gamma-terpinene | 99-85-4 | 6 | 40 |
| | Alpha-Pinene, 98% | 80-56-8 | 0.1 | 8 |
| | Terpinolene | 586-62-9 | 0.1 | 25 |
| | Para-Cymene | 99-87-6 | 0.1 | 6 |
| | Linalyl Acetate | 115-95-7 | 0.1 | 10 |
| | Beta Pinene | 127-91-3 | 0.1 | 10 |
| | Camphor Dextro | 464-49-3 | 0.1 | 10 |
| | Terpinene 4 OL | 562-74-3 | 0.06 | 0.3 |
| | Alpha Terpinene | 99-86-5 | 0.08 | 0.6 |
| | Borneol L | 507-70-0 | 0.1 | 5 |
| | Camphene | 79-92-5 | 0.1 | 3 |
| | Decanal | 112-31-2 | 0.08 | 0.6 |
| | Dodecanal | 112-54-9 | 0.08 | 0.6 |
| | Fenchol Alpha | 512-13-0 | 0.001 | 0.1 |
| | Geranyl Acetate | 105-87-3 | 0.08 | 0.6 |
| | Isoborneol | 124-76-5 | 0.1 | 2 |
| | 2-Methyl 1,3-cyclohexadiene | 30640-46-1, 1888- | 0.1 | 2 |
| | | 90-0 | | |
| | Myrcene | 123-35-3 | 0.1 | 5 |
| | Nonanal | 124-19-6 | 0.001 | 0.2 |
| | Octanal | 124-13-0 | 0.05 | 0.3 |
| | Tocopherol Gamma (TENOX ®) | 54-28-4 | 0.001 | 0.2 |
| Blend 67 | D-Limonene | 5989-27-5 | 20 | 99 |
| | Linalool Coeur | 78-70-6 | 5 | 30 |
| | Alpha-Pinene, 98% | 80-56-8 | 0.1 | 15 |
| | Terpinolene | 586-62-9 | 5 | 30 |
| | Para-Cymene | 99-87-6 | 5 | 30 |
| | Linalyl Acetate | 115-95-7 | 0.1 | 15 |
| | Beta Pinene | 127-91-3 | 0.1 | 15 |
| | Alpha Terpinene | 99-86-5 | 0.1 | 15 |
| | Camphene | 79-92-5 | 0.1 | 20 |
| | Myrcene | 123-35-3 | 0.1 | 30 |
| Blend 68 | D-Limonene | 5989-27-5 | 0.08 | 1 |
| | Thyme Oil Red | 8007-46-3 | 0.1 | 4 |
| | Thymol (crystal) | 89-83-8 | 30 | 99 |
| | alpha-Terpineol | 98-55-5 | 0.1 | 6 |
| | Para-Cymene | 99-87-6 | 10 | 60 |
| | Linalyl Acetate | 115-95-7 | 0.1 | 5 |
| | Caryophyllene-B | 87-44-5 | 0.1 | 10 |
| | Borneol L | 507-70-0 | 0.1 | 6 |
| | Myrcene | 123-35-3 | 0.1 | 4 |
| | Tea Tree Oil | | 0.1 | 6 |
| | Cypress Oil | | 0.1 | 10 |
| | Peppermint Terpenes | 8006-90-4 | 0.1 | 30 |
| | Linalool 90 | | 0.1 | 10 |
| Blend 69 | D-Limonene | 5989-27-5 | 30 | 99 |
| | Citral | 5392-40-5 | 0.1 | 25 |
| | gamma-terpinene | 99-85-4 | 5 | 30 |
| | Alpha-Pinene, 98% | 80-56-8 | 0.1 | 5 |
| | alpha-Terpineol | 98-55-5 | 0.1 | 15 |
| | Terpinolene | 586-62-9 | 0.1 | 20 |
| | Lime Distilled Oil | | 0.06 | 0.3 |
| | Lime Expressed Oil | | 0.06 | 0.3 |
| | Linalyl Acetate | 115-95-7 | 0.1 | 6 |
| | Caryophyllene-B | 87-44-5 | 0.06 | 0.3 |
| | Beta Pinene | 127-91-3 | 0.1 | 8 |
| | Terpinene 4 OL | 562-74-3 | 0.005 | 0.2 |
| | Alpha Terpinene | 99-86-5 | 0.1 | 6 |
| | Borneol L | 507-70-0 | 0.1 | 5 |
| | Camphene | 79-92-5 | 0.1 | 2 |
| | Geranyl Acetate | 105-87-3 | 0.08 | 0.6 |
| | Isoborneol | 124-76-5 | 0.06 | 0.3 |
| | Linalool 90 | | 0.1 | 3 |
| | Camphor Gum | | 0.005 | 0.2 |
| | Aldehyde C-10 | | 0.005 | 0.2 |
| | Aldehyde C-12 | | 0.06 | 0.3 |
| Blend 70 | Eugenol | 97-53-0 | 0.003 | 0.1 |
| | Eucalyptol (1,8 Cineole) | | 0.05 | 0.3 |
| | Methyl Salicylate | | 60 | 99.9 |
| | Linalool 90 | | 0.05 | 0.3 |
| | Ethyl Salicylate | | 0.05 | 0.3 |
| Blend 71 | Tetrahydrolinalool | 78-69-3 | 6 | 35 |
| | Hercolyn D | 8050-15-5 | 0.1 | 25 |
| | Isopropyl myristate | 110-27-0 | 0.1 | 20 |
| | Piperonal (aldehyde)[Heliotropine] | 120-57-0 | 5 | 30 |
| | Ethyl Linalool | 10339-55-6 | 5 | 30 |
| | Triethyl Citrate | 77-93-0 | 0.1 | 30 |
| | Dipropylene glycol (DPG) | 246-770-3 | 5 | 30 |
| | Cinnamic Alcohol | 104-54-1 | 0.1 | 5 |
| | Eugenol | 97-53-0 | 0.1 | 5 |
| | Phenyl Ethyl Alcohol | 60-12-8 | 10 | 65 |
| | Iso Eugenol | | 0.08 | 1 |
| | Methyl Dihydrojasmonate | | 5 | 30 |
| Blend 72 | Linalool Coeur | 78-70-6 | 8 | 40 |
| | Tetrahydrolinalool | 78-69-3 | 10 | 70 |
| | Vanillin | 121-33-5 | 0.1 | 8 |
| | Isopropyl myristate | 110-27-0 | 15 | 85 |
| | Piperonal (aldehyde)[Heliotropine] | 120-57-0 | 5 | 30 |
| | Piperonyl Alcohol | 495-76-1 | 5 | 30 |
| | Geraniol Fine FCC | 106-24-1 | 5 | 30 |
| Blend 73 | Blend 11 | | 50 | 99 |
| | Stock 10% SLS Solution | | 5 | 30 |
| Blend 74 | Polyglycerol-4-oleate | 9007-48-1 | 0.1 | 3 |
| | Lecithin | 8002-43-5 | 0.08 | 0.6 |
| | Water | 7732-18-5 | 5 | 30 |
| | Blend 11 | | 50 | 99 |
| Blend 75 | Potassium Sorbate | 590-00-1 or 24634- | 0.1 | 4 |
| | | 61-5 | | |
| | Xanthan Gum | 11138-66-2 | 0.08 | 1 |
| | Water | 7732-18-5 | 45 | 99 |
| | Blend 74 | | 10 | 50 |
| Blend 76 | Potassium Sorbate | 590-00-1 or 24634- | 0.1 | 2 |
| | | 61-5 | | |
| | Polyglycerol-4-oleate | 9007-48-1 | 0.1 | 2 |
| | Xanthan Gum | 11138-66-2 | 0.08 | 1 |
| | Lecithin | 8002-43-5 | 0.06 | 0.3 |
| | Water | 7732-18-5 | 20 | 99 |
| | Blend 11 | | 15 | 99 |
| Blend 77 | Thyme Oil White | 8007-46-3 | 0.1 | 25 |
| | Wintergreen Oil | 68917-75-9 | 2 | 55 |
| | Isopropyl myristate | 110-27-0 | 1 | 40 |
| | Potassium Sorbate | 590-00-1 or 24634- | 0.06 | 0.3 |
| | | 61-5 | | |
| | Polyglycerol-4-oleate | 9007-48-1 | 0.1 | 2 |
| | Xanthan Gum | 11138-66-2 | 0.08 | 1 |
| | Lecithin | 8002-43-5 | 0.06 | 0.3 |
| | Water | 7732-18-5 | 20 | 99 |
| Blend 78 | Polyglycerol-4-oleate | 9007-48-1 | 0.1 | 3 |
| | Lecithin | 8002-43-5 | 0.08 | 0.6 |
| | Water | 7732-18-5 | 5 | 30 |
| | Blend 11 | | 50 | 99 |
| Blend 79 | Water | 7732-18-5 | 0.1 | 20 |
| | Blend 74 | | 40 | 99 |
| | Stock 2.5% Xanthan-1% Ksorbate | | 6 | 40 |
| Blend 80 | Water | 7732-18-5 | 0.1 | 10 |
| | Blend 78 | | 45 | 99 |
| | Stock 2.5% Xanthan-1% Ksorbate | | 6 | 40 |
| Blend 81 | Potassium Sorbate | 590-00-1 or 24634- | 0.1 | 4 |
| | | 61-5 | | |
| | Xanthan Gum | 11138-66-2 | 0.08 | 1 |
| | Water | 7732-18-5 | 45 | 99 |
| | Blend 78 | | 10 | 50 |
| Blend 82 | Blend 1 | | 0.1 | 8 |
| | Water | | 60 | 99 |
| Blend 83 | Polyglycerol-4-oleate | 9007-48-1 | 0.1 | 3 |
| | Lecithin | 8002-43-5 | 0.08 | 0.6 |
| | Water | 7732-18-5 | 5 | 30 |
| | Blend 11 | | 50 | 99 |
| Blend 84 | Potassium Sorbate | 590-00-1 or 24634- | 0.1 | 4 |
| | | 61-5 | | |
| | Xanthan Gum | 11138-66-2 | 0.08 | 1 |
| | Water | 7732-18-5 | 45 | 99 |
| | Blend 83 | | 10 | 50 |
| Blend 85 | Citronella Oil | 106-22-9 | 0.08 | 0.6 |
| | Carbopol 940 | [9003-01-4] | 0.08 | 0.6 |
| | BHT (butylated hydroxytoluene) | 128-37-0 | 0.06 | 0.3 |
| | Water | 7732-18-5 | 30 | 99 |
| | Emulsifying Wax | 67762-27-0, 9005- | 8 | 40 |
| | | 67-8 | | |
| | Light Liquid Paraffin | 8012-95-1 | 0.1 | 10 |
| | White Soft Paraffin | [8009-03-8] | 0.1 | 25 |
| | Sodium Metabisulphate | [7681-57-4] | 0.08 | 1 |
| | Propylene Glycol | [57-55-6] | 0.1 | 6 |
| | Methyl Paraben | [99-76-3] | 0.08 | 0.6 |
| | Propyl Paraben | [94-13-3] | 0.005 | 0.2 |
| | Cresmer RH40 hydrogenated castor oil | [61791-12-6] | 0.1 | 15 |
| | Triethanolamine | [102-71-6] | 0.08 | 0.6 |
| | Vitamin E Acetate | [58-95-7] | 0.002 | 0.08 |
| | Disodium EDTA | [139-33-3] | 0.005 | 0.2 |
| | Blend 1 | | 0.1 | 15 |
| Blend 86 | Span 80 | 1338-43-8 | 0.005 | 0.2 |
| | Sodium Benzoate | 532-32-1 | 0.08 | 0.6 |
| | Isopar M | 64742-47-8 | 15 | 85 |
| | A46 Propellant | | 8 | 45 |
| | Water | 7732-18-5 | 25 | 99 |
| | Isopropyl alcohol | 67-63-0 | 0.1 | 5 |
| | Blend 8 | | 6 | 40 |
| Blend 87 | Isopar M | 64742-47-8 | 30 | 99 |
| | A46 Propellant | | 20 | 99 |
| | Isopropyl alcohol | 67-63-0 | 0.1 | 10 |
| | Blend 25 | | 0.1 | 20 |
| Blend 88 | Isopar M | 64742-47-8 | 30 | 99 |
| | A46 Propellant | | 20 | 99 |
| | Bifenthrin | 83657-04-3 | 0.005 | 0.2 |
| | Isopropyl alcohol | 67-63-0 | 0.1 | 10 |
| | Blend 25 | | 0.1 | 20 |
| Blend 89 | Isopar M | 64742-47-8 | 30 | 99 |
| | A46 Propellant | | 20 | 99 |
| | Blend 20 | | 0.1 | 20 |
| Blend 90 | Potassium Sorbate | 590-00-1 or 24634- | 0.06 | 0.3 |
| | | 61-5 | | |
| | Polyglycerol-4-oleate | 9007-48-1 | 0.08 | 0.6 |
| | Xanthan Gum | 11138-66-2 | 0.08 | 0.6 |
| | Lecithin | 8002-43-5 | 0.003 | 0.1 |
| | Water | 7732-18-5 | 45 | 99 |
| | Isopropyl alcohol | 67-63-0 | 0.1 | 8 |
| | Blend 35 | | 8 | 45 |
| Blend 91 | Potassium Sorbate | 590-00-1 or 24634- | 0.06 | 0.3 |
| | | 61-5 | | |
| | Polyglycerol-4-oleate | 9007-48-1 | 0.08 | 0.6 |
| | Xanthan Gum | 11138-66-2 | 0.08 | 1 |
| | Lecithin | 8002-43-5 | 0.003 | 0.1 |
| | Water | 7732-18-5 | 50 | 99 |
| | Blend 35 | | 8 | 40 |
| Blend 92 | Isopropyl myristate | 110-27-0 | 0.1 | 10 |
| | Geraniol Fine FCC | 106-24-1 | 0.1 | 8 |
| | Potassium Sorbate | 590-00-1 or 24634- | 0.06 | 0.3 |
| | | 61-5 | | |
| | Polyglycerol-4-oleate | 9007-48-1 | 0.1 | 2 |
| | Xanthan Gum | 11138-66-2 | 0.08 | 1 |
| | Lecithin | 8002-43-5 | 0.05 | 0.2 |
| | Water | 7732-18-5 | 50 | 99 |
| | Blend 68 | | 0.1 | 10 |
| | Isopropyl alcohol | 67-63-0 | 0.1 | 8 |
| Blend 93 | Wintergreen Oil | 68917-75-9 | 0.1 | 15 |
| | Isopropyl myristate | 110-27-0 | 0.1 | 10 |
| | Thyme Oil Red | 8007-46-3 | 0.1 | 6 |
| | Stock 0.3% SLS-0.1% Xanthan Soln | | 55 | 99 |
| Blend 94 | Stock 0.3% SLS & 0.1% Xanthan Soln | | 60 | 99 |
| | Blend 38 | | 0.1 | 15 |
| Blend 95 | Lecithin, Soya | 8030-76-0 | 0.08 | 0.6 |
| | Polyglycerol-4-oleate | 9007-48-1 | 0.1 | 3 |
| | Water | 7732-18-5 | 5 | 30 |
| | Blend 11 | | 50 | 99 |
| Blend 96 | Thyme Oil White | 8007-46-3 | 20 | 99 |
| | Isopropyl myristate | 110-27-0 | 15 | 95 |
| | Lecithin, Soya | 8030-76-0 | 0.08 | 0.6 |
| | Polyglycerol-4-oleate | 9007-48-1 | 0.1 | 3 |
| | Water | 7732-18-5 | 5 | 30 |
| | Wintergreen Oil | | 10 | 65 |
| Blend 97 | Lecithin, Soya | 8030-76-0 | 0.06 | 0.3 |
| | Polyglycerol-4-oleate | 9007-48-1 | 0.1 | 3 |
| | Water | 7732-18-5 | 5 | 30 |
| | Blend 7 | | 50 | 99 |
| Blend 98 | Thyme Oil White | 8007-46-3 | 10 | 55 |
| | Wintergreen Oil | 68917-75-9 | 20 | 99 |
| | Vanillin | 121-33-5 | 0.1 | 4 |
| | Isopropyl myristate | 110-27-0 | 15 | 90 |
| | Lecithin, Soya | 8030-76-0 | 0.06 | 0.3 |
| | Polyglycerol-4-oleate | 9007-48-1 | 0.1 | 3 |
| | Water | 7732-18-5 | 5 | 30 |
| Blend 99 | Polyglycerol-4-oleate | 9007-48-1 | 0.1 | 6 |
| | Water | 7732-18-5 | 0.1 | 25 |
| | Blend 11 | | 50 | 99 |
| Blend 100 | Thyme Oil White | 8007-46-3 | 20 | 99 |
| | Isopropyl myristate | 110-27-0 | 15 | 95 |
| | Polyglycerol-4-oleate | 9007-48-1 | 0.1 | 6 |
| | Water | 7732-18-5 | 0.1 | 25 |
| | Wintergreen Oil | | 10 | 65 |
| Blend 101 | Potassium Sorbate | 590-00-1 or 24634- | 0.06 | 0.3 |
| | | 61-5 | | |
| | Polyglycerol-4-oleate | 9007-48-1 | 0.1 | 6 |
| | Xanthan Gum | 11138-66-2 | 0.08 | 1 |
| | Water | 7732-18-5 | 50 | 99 |
| | Blend 97 | | 6 | 35 |
| Blend 102 | D-Limonene | 5989-27-5 | 0.1 | 15 |
| | Thyme Oil White | 8007-46-3 | 0.1 | 5 |
| | Lecithin, Soya | 8030-76-0 | 0.001 | 0.04 |
| | Potassium Sorbate | 590-00-1 or 24634- | 0.06 | 0.3 |
| | | 61-5 | | |
| | Polyglycerol-4-oleate | 9007-48-1 | 0.1 | 6 |
| | Xanthan Gum | 11138-66-2 | 0.08 | 1 |
| | Water | 7732-18-5 | 50 | 99 |
| | Wintergreen Oil | | 0.1 | 10 |
| Blend 103 | Potassium Sorbate | 590-00-1 or 24634- | 0.06 | 0.3 |
| | | 61-5 | | |
| | Xanthan Gum | 11138-66-2 | 0.08 | 1 |
| | Water | 7732-18-5 | 50 | 99 |
| | Blend 95 | | 6 | 35 |
| Blend 104 | Thyme Oil White | 8007-46-3 | 0.1 | 10 |
| | Isopropyl myristate | 110-27-0 | 0.1 | 10 |
| | Lecithin, Soya | 8030-76-0 | 0.002 | 0.08 |
| | Potassium Sorbate | 590-00-1 or 24634- | 0.06 | 0.3 |
| | | 61-5 | | |
| | Polyglycerol-4-oleate | 9007-48-1 | 0.06 | 0.3 |
| | Xanthan Gum | 11138-66-2 | 0.08 | 1 |
| | Water | 7732-18-5 | 55 | 99 |
| | Wintergreen Oil | | 0.1 | 8 |
| Blend 105 | Potassium Sorbate | 590-00-1 or 24634- | 0.06 | 0.3 |
| | | 61-5 | | |
| | Xanthan Gum | 11138-66-2 | 0.08 | 1 |
| | Water | 7732-18-5 | 50 | 99 |
| | Blend 99 | | 6 | 35 |
| Blend 106 | Thyme Oil White | 8007-46-3 | 0.1 | 10 |
| | Wintergreen Oil | 68917-75-9 | 0.1 | 8 |
| | Isopropyl myristate | 110-27-0 | 0.1 | 10 |
| | Potassium Sorbate | 590-00-1 or 24634- | 0.06 | 0.3 |
| | | 61-5 | | |
| | Polyglycerol-4-oleate | 9007-48-1 | 0.08 | 0.6 |
| | Xanthan Gum | 11138-66-2 | 0.08 | 1 |
| | Water | 7732-18-5 | 55 | 99 |
| Blend 107 | Potassium Sorbate | 590-00-1 or 24634- | 0.1 | 4 |
| | | 61-5 | | |
| | Xanthan Gum | 11138-66-2 | 0.1 | 8 |
| | Water | 7732-18-5 | 60 | 99 |
| Blend 108 | Sodium Benzoate | 532-32-1 | 0.1 | 6 |
| | Water | 7732-18-5 | 60 | 99 |
| Blend 109 | Span 80 | 1338-43-8 | 0.1 | 4 |
| | Tween 80 | | 0.1 | 5 |
| | Isopar M | 64742-47-8 | 8 | 40 |
| | Water | 7732-18-5 | 35 | 99 |
| | Blend 8 | | 0.1 | 10 |
| | 2% Sodium Benzoate | | 6 | 35 |
| Blend 110 | D-Limonene | 5989-27-5 | 0.1 | 5 |
| | Thyme Oil White | 8007-46-3 | 0.1 | 2 |
| | Wintergreen Oil | 68917-75-9 | 0.1 | 3 |
| | Span 80 | 1338-43-8 | 0.1 | 4 |
| | Tween 80 | | 0.1 | 5 |
| | Sodium Benzoate | 532-32-1 | 0.08 | 0.6 |
| | Isopar M | 64742-47-8 | 8 | 40 |
| | Water | 7732-18-5 | 40 | 99 |
| Blend 111 | Propellent A70 | | 10 | 65 |
| | Blend 109 | | 45 | 99 |
| Blend 112 | D-Limonene | 5989-27-5 | 0.1 | 5 |
| | Thyme Oil White | 8007-46-3 | 0.08 | 1 |
| | Wintergreen Oil | 68917-75-9 | 0.1 | 3 |
| | Span 80 | 1338-43-8 | 0.1 | 3 |
| | Tween 80 | | 0.1 | 5 |
| | Sodium Benzoate | 532-32-1 | 0.08 | 0.6 |
| | Isopar M | 64742-47-8 | 6 | 35 |
| | Water | 7732-18-5 | 35 | 99 |
| | Propellent A70 | | 10 | 65 |
| Blend 113 | Sodium Lauryl Sulfate | 151-21-3 | 5 | 30 |
| | Water | 7732-18-5 | 55 | 99 |
| Blend 114 | Sodium Lauryl Sulfate | 151-21-3 | 0.08 | 1 |
| | Xanthan Gum | 11138-66-2 | 0.06 | 0.3 |
| | Water | 7732-18-5 | 60 | 99.9 |
| Blend 115 | Citronella Oil | 106-22-9 | 0.08 | 0.6 |
| | Carbopol 940 | [9003-01-4] | 0.08 | 0.6 |
| | BHT (butylated hydroxytoluene) | 128-37-0 | 0.06 | 0.3 |
| | Water | 7732-18-5 | 30 | 99 |
| | Emulsifying Wax | 67762-27-0, 9005- | 8 | 40 |
| | | 67-8 | | |
| | Light Liquid Paraffin | 8012-95-1 | 0.1 | 10 |
| | White Soft Paraffin | [8009-03-8] | 0.1 | 25 |
| | Sodium Metabisulphate | [7681-57-4] | 0.08 | 1 |
| | Propylene Glycol | [57-55-6] | 0.1 | 6 |
| | Cresmer RH40 hydrogenated castor oil | [61791-12-6] | 0.1 | 15 |
| | Triethanolamine | [102-71-6] | 0.08 | 0.6 |
| | Vitamin E Acetate | [58-95-7] | 0.002 | 0.08 |
| | Disodium EDTA | [139-33-3] | 0.005 | 0.2 |
| | Blend 1 | | 0.1 | 15 |
| Blend 116 | Water | 7732-18-5 | 20 | 99 |
| | Blend 75 | | 35 | 99 |
| Blend 117 | D-Limonene | 5989-27-5 | 0.1 | 10 |
| | Thyme Oil White | 8007-46-3 | 0.1 | 15 |
| | Benzyl Alcohol | 100-51-6 | 8 | 50 |
| | Isopar M | 64742-47-8 | 10 | 65 |
| | Water | 7732-18-5 | 25 | 99 |
| | Bifenthrin | 83657-04-3 | 0.005 | 0.2 |
| | Blend 63 | | 0.1 | 15 |
| | Stock 10% SLS Solution | | 0.1 | 10 |
| Blend 118 | Thyme Oil White | 8007-46-3 | 0.1 | 2 |
| | Wintergreen Oil | 68917-75-9 | 0.1 | 3 |
| | Isopropyl myristate | 110-27-0 | 0.1 | 3 |
| | Sodium Lauryl Sulfate | 151-21-3 | 0.002 | 0.08 |
| | Water | 7732-18-5 | 60 | 99 |
| Blend 119 | Thyme Oil White | 8007-46-3 | 0.1 | 4 |
| | Wintergreen Oil | 68917-75-9 | 0.1 | 8 |
| | Isopropyl myristate | 110-27-0 | 0.1 | 5 |
| | AgSorb clay carrier | | 60 | 99 |
| Blend 120 | Thyme Oil White | 8007-46-3 | 0.1 | 4 |
| | Wintergreen Oil | 68917-75-9 | 0.1 | 8 |
| | Isopropyl myristate | 110-27-0 | 0.1 | 5 |
| | DG Lite | | 60 | 99 |
| Blend 121 | D-Limonene | 5989-27-5 | 15 | 75 |
| | Thyme Oil White | 8007-46-3 | 0.1 | 4 |
| | Linalool Coeur | 78-70-6 | 0.08 | 0.6 |
| | Tetrahydrolinalool | 78-69-3 | 0.08 | 0.6 |
| | Vanillin | 121-33-5 | 0.002 | 0.08 |
| | Isopropyl myristate | 110-27-0 | 0.08 | 0.6 |
| | Piperonal (aldehyde) [Heliotropine] | 120-57-0 | 0.08 | 0.6 |
| | Blend 66 | | 0.1 | 10 |
| | Geraniol 60 | 106-24-1 | 0.06 | 0.3 |
| | Triethyl Citrate | 77-93-0 | 0.08 | 0.6 |
| | Water | 7732-18-5 | 35 | 99 |
| | Stock 10% SLS Solution | | 0.1 | 10 |
| Blend 122 | Miracle Gro (Sterile) | | 60 | 99 |
| | Blend 11 | | 0.1 | 15 |
| Blend 123 | Thyme Oil White | 8007-46-3 | 15 | 75 |
| | Amyl Butyrate | 540-18-1 | 15 | 75 |
| | Anise Star Oil | | 30 | 99 |
| | Genistein | | 0.001 | 0.1 |
| Blend 124 | Linalool Coeur | | 0.1 | 20 |
| | Tetrahydrolinalool | | 0.1 | 25 |
| | Vanillin | | 0.1 | 2 |
| | Isopropyl myristate | | 0.1 | 30 |
| | Piperonal (aldehyde) [Heliotropine] | | 0.1 | 30 |
| | Geraniol Fine FCC | | 0.1 | 15 |
| | Triethyl Citrate | | 0.1 | 30 |
| | Thyme Oil White | | 30 | 99 |
| Blend 125 | D-Limonene | 5989-27-5 | 5 | 30 |
| | Linalool Coeur | 78-70-6 | 8 | 40 |
| | Tetrahydrolinalool | 78-69-3 | 15 | 75 |
| | Vanillin | 121-33-5 | 0.1 | 8 |
| | Isopropyl myristate | 110-27-0 | 15 | 85 |
| | Piperonal (aldehyde) | 120-57-0 | 5 | 30 |
| | Geraniol 60 | | 5 | 30 |
| Blend 126 | D-Limonene | 5989-27-5 | 45 | 99 |
| | Thyme Oil White | 8007-46-3 | 0.1 | 10 |
| | Linalool Coeur | 78-70-6 | 0.1 | 2 |
| | Tetrahydrolinalool | 78-69-3 | 0.1 | 3 |
| | Vanillin | 121-33-5 | 0.005 | 0.2 |
| | Isopropyl myristate | 110-27-0 | 0.1 | 3 |
| | Piperonal (aldehyde) [Heliotropine] | 120-57-0 | 0.1 | 3 |
| | Blend 66 | | 5 | 30 |
| | Geraniol 60 | | 0.1 | 2 |
| | Triethyl Citrate | 77-93-0 | 0.1 | 3 |

The foregoing Table 1 provides exemplary combinations of ingredients for blends useful in methods in accordance with the invention. In many cases a particular ingredient is listed very specifically such as, for example, with reference to a CAS number and/or particular modifiers of the basic name of the ingredient. Such specific listings are non-limiting examples of types of ingredients, and similar ingredients (such as, for example, with different CAS numbers and/or variant forms of the type of ingredient) can be substituted in compositions that are used in methods within the scope of certain embodiments of the invention.

The foregoing Table 1 also provides an exemplary range of amounts of each ingredient expressed as a weight/weight percentage of the listed blend. The exemplary range for each ingredient in each blend is provided as a number in the fourth column indicating a value at the low end of such exemplary range, and in the fifth column indicating a value at the high end of such exemplary range. The provided ranges are exemplary; other useful ranges exist and are expressly within the scope of certain embodiments of the invention. Namely, other high and low amounts defining other useful ranges and/or amounts of the listed ingredients, can include 1%, 2%, 5%, 10%, 15%, 20%, 25%, 40%, 50%, 60%, 75%, 85%, 95%, 110%, 125%, 150%, 175%, 200%, 250%, 300%, 400%, 500%, 750%, 900%, or 1000% of the amount listed as the low amount and/or the high amount, with the caveat that the relative percentage of any given ingredient cannot exceed 99.99% of the total blend of ingredients.

Furthermore, other blends useful in methods in accordance with the present invention are shown in the following table.

TABLE 2

| Ingredients | Exemplified form | % Range 1 | | % Range 2 | | % Range 3 | | % Range 4 | | |
|---|---|---|---|---|---|---|---|---|---|---|
| | | | | | | | | | | Exem- |
| | | | | | | | | | | plified |
| Example 1 - Ingredient Family 1 | | | | | | | | | | % (w/w) |
| Linalool | Linalool Coeur | 0.66% | 19.80% | 3.30% | 9.90% | 4.95% | 8.25% | 5.94% | 7.26% | 6.60% |
| Base Oil | Soy Bean Oil | 2.40% | 72.00% | 12.00% | 36.00% | 18.00% | 30.00% | 21.60% | 26.40% | 24.00% |
| Thymol | Thymol (crystal) | 3.72% | 99.00% | 18.60% | 55.80% | 27.90% | 46.50% | 33.48% | 40.92% | 37.20% |
| Pinene | Alpha-Pinene, 98% | 0.38% | 11.40% | 1.90% | 5.70% | 2.85% | 4.75% | 3.42% | 4.18% | 3.80% |
| Cymene | Para-Cymene | 2.84% | 85.17% | 14.20% | 42.59% | 21.29% | 35.49% | 25.55% | 31.23% | 28.39% |
| Example 2 - Ingredient Family 2 | | | | | | | | | | |
| Thyme Oil | Thyme Oil White | 2.06% | 61.80% | 10.30% | 30.90% | 15.45% | 25.75% | 18.54% | 22.66% | 20.60% |
| Wintergreen Oil | Wintergreen Oil | 4.51% | 99.00% | 22.55% | 67.65% | 33.83% | 56.38% | 40.59% | 49.61% | 45.10% |
| Isopropyl myristate | Isopropyl myristate | 3.43% | 99.00% | 17.15% | 51.45% | 25.73% | 42.88% | 30.87% | 37.73% | 34.30% |
| Example 3 - Ingredient Family 3 | | | | | | | | | | |
| Thyme Oil | Thyme Oil White | 2.48% | 74.25% | 12.38% | 37.13% | 18.56% | 30.94% | 22.28% | 27.23% | 24.75% |
| Amyl Butyrate | Amyl Butyrate | 2.30% | 69.12% | 11.52% | 34.56% | 17.28% | 28.80% | 20.74% | 25.34% | 23.04% |
| Anise Star Oil | Anise Star Oil | 5.22% | 99.00% | 26.11% | 78.32% | 39.16% | 65.26% | 46.99% | 57.43% | 52.21% |
| Example 4 - Ingredient Family 4 | | | | | | | | | | |
| Thyme Oil | Thyme Oil White | 2.48% | 74.25% | 12.38% | 37.13% | 18.56% | 30.94% | 22.28% | 27.23% | 24.75% |
| Amyl Butyrate | Amyl Butyrate | 2.30% | 69.12% | 11.52% | 34.56% | 17.28% | 28.80% | 20.74% | 25.34% | 23.04% |
| Anise Star Oil | Anise Star Oil | 5.22% | 99.00% | 26.10% | 78.30% | 39.15% | 65.25% | 46.98% | 57.42% | 52.20% |
| Isoflavone | Genistein | 0.001% | 5.00% | 0.005% | 0.02% | 0.008% | 0.012% | 0.009% | 0.011% | 0.01% |
| Example 5 - Ingredient Family 5 | | | | | | | | | | |
| Thyme Oil | Thyme Oil White | 2.05% | 61.50% | 10.25% | 30.75% | 15.38% | 25.63% | 18.45% | 22.55% | 20.50% |
| Wintergreen Oil | Wintergreen Oil | 4.50% | 99.00% | 22.50% | 67.50% | 33.75% | 56.25% | 40.50% | 49.50% | 45.00% |
| Vanillin | Vanillin | 0.11% | 5.00% | 0.55% | 1.65% | 0.83% | 1.38% | 0.99% | 1.21% | 1.10% |
| Isopropyl myristate | Isopropyl myristate | 3.34% | 99.00% | 16.70% | 50.10% | 25.05% | 41.75% | 30.06% | 36.74% | 33.40% |
| Example 6 - Ingredient Family 6 | | | | | | | | | | |
| Limonene | D-Limonene | 5.63% | 99.00% | 28.15% | 84.45% | 42.23% | 70.38% | 50.67% | 61.93% | 56.30% |
| Thyme Oil | Thyme Oil White | 1.24% | 37.14% | 6.19% | 18.57% | 9.29% | 15.48% | 11.14% | 13.62% | 12.38% |
| Wintergreen Oil | Wintergreen Oil | 3.13% | 93.96% | 15.66% | 46.98% | 23.49% | 39.15% | 28.19% | 34.45% | 31.32% |
| Example 7 - Ingredient Family 7 | | | | | | | | | | |
| Potassium Sorbate | Potassium Sorbate | 0.10% | 5.00% | 0.50% | 1.50% | 0.75% | 1.25% | 0.90% | 1.10% | 1.00% |
| Xanthan Gum | Xanthan Gum | 0.03% | 5.00% | 0.14% | 0.42% | 0.21% | 0.35% | 0.25% | 0.31% | 0.28% |
| Water | Water | 8.18% | 99.00% | 40.91% | 99.00% | 61.37% | 99.00% | 73.64% | 90.00% | 81.82% |
| Blend 74 | Blend 74 | 1.69% | 50.7% | 8.45% | 25.35% | 12.68% | 21.13% | 15.21% | 18.59% | 16.90% |
| Example 8 - Ingredient Family 8 | | | | | | | | | | |
| Isopropyl myristate | Isopropyl myristate | 4.84% | 99.00% | 24.18% | 72.53% | 36.26% | 60.44% | 43.52% | 53.19% | 48.35% |
| Geraniol | Geraniol Fine FCC | 1.50% | 44.94% | 7.49% | 22.47% | 11.24% | 18.73% | 13.48% | 16.48% | 14.98% |
| Thyme Oil | Thyme Oil White | 3.67% | 99.00% | 18.34% | 55.01% | 27.50% | 45.84% | 33.00% | 40.34% | 36.67% |
| Example 9 - Ingredient Family 9 | | | | | | | | | | |
| Limonene | D-Limonene | 0.99% | 29.70% | 4.95% | 14.85% | 7.43% | 12.38% | 8.91% | 10.89% | 9.90% |
| Linalool | Linalool Coeur | 1.41% | 42.42% | 7.07% | 21.21% | 10.61% | 17.68% | 12.73% | 15.55% | 14.14% |
| Tetrahydrolinalool | Tetrahydrolinalool | 2.43% | 72.87% | 12.15% | 36.44% | 18.22% | 30.36% | 21.86% | 26.72% | 24.29% |
| Vanillin | Vanillin | 0.25% | 7.44% | 1.24% | 3.72% | 1.86% | 3.10% | 2.23% | 2.73% | 2.48% |
| Isopropyl myristate | Isopropyl myristate | 2.89% | 86.76% | 14.46% | 43.38% | 21.69% | 36.15% | 26.03% | 31.81% | 28.92% |
| Piperonal | Piperonal (aldehyde) | 1.00% | 29.91% | 4.99% | 14.96% | 7.48% | 12.46% | 8.97% | 10.97% | 9.97% |
| Geraniol | Geraniol Fine FCC | 1.03% | 30.90% | 5.15% | 15.45% | 7.73% | 12.88% | 9.27% | 11.33% | 10.30% |
| Example 10 - Ingredient Family 10 | | | | | | | | | | |
| Limonene | D-Limonene | 2.85% | 85.38% | 14.23% | 42.69% | 21.35% | 35.58% | 25.61% | 31.31% | 28.46% |
| Thyme Oil | Thyme Oil White | 3.13% | 93.87% | 15.65% | 46.94% | 23.47% | 39.11% | 28.16% | 34.42% | 31.29% |
| Blend 63 | Blend 63 | 4.03% | 99.00% | 20.13% | 60.38% | 30.19% | 50.31% | 36.23% | 44.28% | 40.25% |
| Example 11 - Ingredient Family 11 | | | | | | | | | | |
| Limonene | D-Limonene | 0.96% | 28.89% | 4.82% | 14.45% | 7.22% | 12.04% | 8.67% | 10.59% | 9.63% |
| BSO | BSO | 2.67% | 79.98% | 13.33% | 39.99% | 20.00% | 33.33% | 23.99% | 29.33% | 26.66% |
| Linalool | Linalool Coeur | 0.98% | 29.46% | 4.91% | 14.73% | 7.37% | 12.28% | 8.84% | 10.80% | 9.82% |
| Tetrahydrolinalool | Tetrahydrolinalool | 1.18% | 35.43% | 5.91% | 17.72% | 8.86% | 14.76% | 10.63% | 12.99% | 11.81% |
| Vanillin | Vanillin | 0.12% | 5.00% | 0.60% | 1.80% | 0.90% | 1.50% | 1.08% | 1.32% | 1.20% |
| Base oil | Mineral Oil White USP | 1.50% | 44.91% | 7.49% | 22.46% | 11.23% | 18.71% | 13.47% | 16.47% | 14.97% |
| Isopropyl myristate | Isopropyl myristate | 1.45% | 43.62% | 7.27% | 21.81% | 10.91% | 18.18% | 13.09% | 15.99% | 14.54% |
| Piperonal | Piperonal (aldehyde) | 0.49% | 14.55% | 2.43% | 7.28% | 3.64% | 6.06% | 4.37% | 5.34% | 4.85% |
| Geraniol | Geraniol Fine FCC | 0.65% | 19.53% | 3.26% | 9.77% | 4.88% | 8.14% | 5.86% | 7.16% | 6.51% |
| Example 12 - Ingredient Family 12 | | | | | | | | | | |
| Thyme Oil | Thyme Oil White | 4.19% | 99.00% | 20.93% | 62.79% | 31.40% | 52.33% | 37.67% | 46.05% | 41.86% |
| Isopropyl myristate | Isopropyl myristate | 3.83% | 99.00% | 19.17% | 57.51% | 28.76% | 47.93% | 34.51% | 42.17% | 38.34% |
| Geraniol | Geraniol Fine FCC | 1.98% | 59.40% | 9.90% | 29.70% | 14.85% | 24.75% | 17.82% | 21.78% | 19.80% |
| Example 13 - Ingredient Family 13 | | | | | | | | | | |
| Linalool | Linalool Coeur | 2.34% | 70.14% | 11.69% | 35.07% | 17.54% | 29.23% | 21.04% | 25.72% | 23.38% |
| Amyl Butyrate | Amyl Butyrate | 2.35% | 70.38% | 11.73% | 35.19% | 17.60% | 29.33% | 21.11% | 25.81% | 23.46% |
| Anise Star Oil | Anise Star Oil | 5.32% | 99.00% | 26.58% | 79.74% | 39.87% | 66.45% | 47.84% | 58.48% | 53.16% |
| Example 14 - Ingredient Family 14 | | | | | | | | | | |
| Linalool | Linalool Coeur | 3.74% | 99.00% | 18.72% | 56.16% | 28.08% | 46.80% | 33.70% | 41.18% | 37.44% |
| Thymol | Thymol | 3.67% | 99.00% | 18.36% | 55.08% | 27.54% | 45.90% | 33.05% | 40.39% | 36.72% |
| Pinene | Alpha-pinene, 98% | 0.47% | 13.98% | 2.33% | 6.99% | 3.50% | 5.83% | 4.19% | 5.13% | 4.66% |
| Cymene | Para-Cymene | 0.19% | 5.61% | 0.94% | 2.81% | 1.40% | 2.34% | 1.68% | 2.06% | 1.87% |
| Anethole | Trans-Anethole | 1.93% | 57.93% | 9.66% | 28.97% | 14.48% | 24.14% | 17.38% | 21.24% | 19.31% |
| Example 15 - Ingredient Family 15 | | | | | | | | | | |
| Limonene | D-Limonene | 2.74% | 82.05% | 13.68% | 41.03% | 20.51% | 34.19% | 24.62% | 30.09% | 27.35% |
| Thyme Oil | Thyme Oil White | 3.01% | 90.24% | 15.04% | 45.12% | 22.56% | 37.60% | 27.07% | 33.09% | 30.08% |
| Lilac Flower Oil | Lilac Flower Oil | 4.26% | 99.00% | 21.30% | 63.90% | 31.95% | 53.25% | 38.34% | 46.86% | 42.57% |
| Example 16 - Ingredient Family 16 | | | | | | | | | | |
| Thyme Oil | Thyme Oil White | 3.82% | 99.00% | 19.11% | 57.32% | 28.66% | 47.76% | 34.39% | 42.03% | 38.21% |
| Wintergreen Oil | Wintergreen Oil | 2.48% | 74.37% | 12.40% | 37.19% | 18.59% | 30.99% | 22.31% | 27.27% | 24.79% |
| Isopropyl Myristate | Isopropyl Myristate | 3.59% | 99.00% | 17.95% | 53.84% | 26.92% | 44.86% | 32.30% | 39.48% | 35.89% |
| vanillin | Vanillin | 0.11% | 5.00% | 0.56% | 1.67% | 0.83% | 1.39% | 1.00% | 1.22% | 1.11% |
| Example 17 - Ingredient Family 17 | | | | | | | | | | |
| Wintergreen Oil | Wintergreen Oil | 2.48% | 74.46% | 12.41% | 37.23% | 18.62% | 31.03% | 22.34% | 27.30% | 24.82% |
| Isopropyl Myristate | Isopropyl Myristate | 3.59% | 99.00% | 17.97% | 53.91% | 26.96% | 44.93% | 32.35% | 39.53% | 35.94% |
| Thyme Oil | Thyme Oil White | 3.92% | 99.00% | 19.62% | 58.86% | 29.43% | 49.05% | 35.32% | 43.16% | 39.24% |
| Example 18 - Ingredient Family 18 | | | | | | | | | | |
| Thyme Oil | Thyme Oil White | 0.46% | 13.8% | 2.30% | 6.90% | 3.45% | 5.75% | 4.14% | 5.06% | 4.60% |
| Wintergreen Oil | Wintergreen Oil | 5.78% | 99.00% | 28.90% | 86.70% | 43.35% | 72.25% | 52.02% | 63.58% | 57.80% |
| Isopropyl Myristate | Isopropyl Myristate | 3.76% | 99.00% | 18.80% | 56.40% | 28.20% | 47.00% | 33.84% | 41.36% | 37.60% |
| Example 19 - Ingredient Family 19 | | | | | | | | | | |
| Thyme Oil | Thyme Oil White | 3.16% | 94.71% | 15.79% | 47.36% | 23.68% | 39.46% | 28.41% | 34.73% | 31.57% |
| Isopropyl myristate | Isopropyl myristate | 3.86% | 99.00% | 19.28% | 57.84% | 28.92% | 48.20% | 34.70% | 42.42% | 38.56% |
| Wintergreen Oil | Wintergreen Oil | 2.99% | 89.61% | 14.94% | 44.81% | 22.40% | 37.34% | 26.88% | 32.86% | 29.87% |
| Example 20 - Ingredient Family 20 | | | | | | | | | | |
| Thyme Oil | Thyme Oil White | 2.06% | 61.80% | 10.30% | 30.90% | 15.45% | 25.75% | 18.54% | 22.66% | 20.60% |
| Isopropyl myristate | Isopropyl myristate | 3.43% | 99.00% | 17.15% | 51.45% | 25.73% | 42.88% | 30.87% | 37.73% | 34.30% |
| Geraniol | Geraniol Fine FCC | 4.51% | 99.00% | 22.55% | 67.65% | 33.83% | 56.38% | 40.59% | 49.61% | 45.10% |
| Example 21 - Ingredient Family 21 | | | | | | | | | | |
| Thyme Oil | Thyme Oil White | 1.24% | 37.14% | 6.19% | 18.57% | 9.29% | 15.48% | 11.14% | 13.62% | 12.38% |
| Wintergreen Oil | Wintergreen Oil | 3.13% | 93.96% | 15.66% | 46.98% | 23.49% | 39.15% | 28.19% | 34.45% | 31.32% |
| Limonene | D-Limonene | 5.63% | 99.00% | 28.15% | 84.45% | 42.23% | 70.38% | 50.67% | 61.93% | 56.30% |
| Example 22 - Ingredient Family 22 | | | | | | | | | | |
| LFO | LFO | 5.01% | 99.00% | 25.07% | 75.20% | 37.60% | 62.66% | 45.12% | 55.14% | 50.13% |
| BSO (Black Seed Oil) | BSO | 4.99% | 99.00% | 24.94% | 74.81% | 37.40% | 62.34% | 44.88% | 54.86% | 49.87% |
| Example 23 - Ingredient Family 23 | | | | | | | | | | |
| LFO | LFO | 8.01% | 99.00% | 40.05% | 99.00% | 60.07% | 99.00% | 72.08% | 88.10% | 80.09% |
| BSO (Black Seed Oil) | BSO | 1.99% | 59.73% | 9.96% | 29.87% | 14.93% | 24.89% | 17.92% | 21.90% | 19.91% |
| Example 24 - Ingredient Family 24 | | | | | | | | | | |
| Thyme Oil | Thyme Oil White, | 2.06% | 61.80% | 10.30% | 30.90% | 15.45% | 25.75% | 18.54% | 22.66% | 20.60% |
| | 1% Thyme Oil Red | | | | | | | | | |
| Wintergreen Oil | Wintergreen Oil | 4.51% | 99.00% | 22.55% | 67.65% | 33.83% | 56.38% | 40.59% | 49.61% | 45.10% |
| Isopropyl myristate | Isopropyl myristate | 3.43% | 99.00% | 17.15% | 51.45% | 25.73% | 42.88% | 30.87% | 37.73% | 34.30% |
| Example 25 - Ingredient Family 25 | | | | | | | | | | |
| Thyme Oil | Thyme Oil White, | 3.14% | 56.68% | 15.71% | 47.12% | 25.13% | 37.69% | 28.27% | 34.55% | 31.41% |
| | 1% Thyme Oil Red | | | | | | | | | |
| Isopropyl myristate | Isopropyl myristate | 3.87% | 73.44% | 19.33% | 57.98% | 30.92% | 46.38% | 34.79% | 42.52% | 38.65% |
| Geraniol | Geraniol Fine FCC | 8.48% | 52.24% | 14.97% | 44.91% | 23.95% | 35.93% | 26.95% | 32.93% | 29.94% |
| Example 26 - Ingredient Family 26 | | | | | | | | | | |
| Geraniol | Geraniol Fine FCC | 0.47% | 8.89% | 2.34% | 7.02% | 3.74% | 5.62% | 4.21% | 5.15% | 4.68% |
| Thyme Oil | Thyme Oil White | 5.10% | 96.44% | 25.38% | 76.14% | 40.61% | 60.91% | 45.68% | 55.76% | 50.76% |
| Linalool | Linalool Coeur | 0.62% | 12.20% | 3.21% | 9.63% | 5.14% | 7.70% | 5.78% | 7.06% | 6.42% |
| Tetrahydrolinalool | Tetrahydrolinalool | 0.88% | 16.76% | 4.41% | 13.23% | 7.06% | 10.58% | 7.94% | 9.70% | 8.82% |
| Vanillin | Vanillin | 0.05% | 1.00% | 0.27% | 0.80% | 0.42% | 0.64% | 0.48% | 0.58% | 0.53% |
| Isopropyl myristate | Isopropyl myristate | 0.91% | 17.21% | 4.53% | 13.59% | 7.25% | 10.87% | 8.15% | 9.97% | 9.06% |
| Piperonal | Piperonal (aldehyde) | 1.07% | 20.24% | 5.33% | 15.98% | 8.52% | 12.78% | 9.58% | 11.72% | 10.65% |
| Triethyl citrate | Triethyl citrate | 0.91% | 17.52% | 4.54% | 13.62% | 7.26% | 10.90% | 8.17% | 9.99% | 9.08% |
| Example 27 - Ingredient Family 27 | | | | | | | | | | |
| Wintergreen Oil | Wintergreen Oil | 4.46% | 84.85% | 22.33% | 67.00% | 35.73% | 57.59% | 40.19% | 49.13% | 44.66% |
| Thyme Oil | Thyme oil white | 2.04% | 38.74% | 10.20% | 30.59% | 16.31% | 24.47% | 18.35% | 22.43% | 20.39% |
| Mineral Oil | White Mineral Oil | 3.49% | 66.41% | 17.48% | 52.43% | 27.96% | 41.94% | 31.46% | 38.45% | 34.95% |
| Example 28 - Ingredient Family 28 | | | | | | | | | | |
| Geraniol | Geraniol 60 | 1.96% | 37.24% | 9.80% | 29.40% | 15.68% | 23.52% | 17.64% | 21.56% | 19.6% |
| Thyme Oil | Thyme Oil White | 4.14% | 78.66% | 20.70% | 62.10% | 33.12% | 49.68% | 37.26% | 45.54% | 41.4% |
| Isopropyl myristate | Isopropyl myristate | 0.38% | 7.22% | 1.90% | 5.70% | 3.04% | 4.56% | 3.42% | 4.18% | 3.8% |
| Mineral Oil | White Mineral Oil | 3.52% | 66.88% | 17.60% | 52.80% | 28.16% | 42.24% | 31.68% | 38.72% | 35.2% |
| Example 29 - Ingredient Family 29 | | | | | | | | | | |
| Geraniol | Geraniol 60 | 2.96% | 56.18% | 14.79% | 44.36% | 23.66% | 35.48% | 26.61% | 32.53% | 29.57% |
| Thyme Oil | Thyme Oil White | 3.12% | 59.38% | 15.63% | 46.88% | 25.00% | 37.50% | 28.13% | 34.38% | 31.25% |
| Isopropyl myristate | Isopropyl myristate | 0.39% | 7.45% | 1.96% | 5.88% | 3.14% | 4.70% | 3.53% | 4.31% | 3.92% |
| Mineral Oil | White Mineral Oil | 3.52% | 67.18% | 17.68% | 53.04% | 28.29% | 42.43% | 31.82% | 38.90% | 35.36% |
| Example 30 - Ingredient Family 30 | | | | | | | | | | |
| Geraniol | Geraniol 60 | 1.65% | 31.43% | 8.27% | 24.81% | 13.23% | 19.85% | 14.89% | 18.19% | 16.54% |
| Thyme Oil | Thyme Oil White | 4.79% | 90.92% | 23.92% | 71.78% | 38.14% | 57.42% | 43.07% | 52.64% | 47.85% |
| Linalool | Linalool Coeur | 0.19% | 3.52% | 0.93% | 2.78% | 1.48% | 2.22% | 1.67% | 2.04% | 1.85% |
| Vanillin | Vanillin | 0.38% | 7.14% | 1.88% | 5.64% | 3.00% | 4.51% | 3.38% | 4.14% | 3.76% |
| Isopropyl myristate | Isopropyl myristate | 1.68% | 30.40% | 8.00% | 24.00% | 12.80% | 19.20% | 14.40% | 17.60% | 16.00% |
| Triethyl citrate | Triethyl citrate | 1.40% | 28.00% | 7.00% | 21.00% | 11.20% | 16.80% | 12.60% | 15.40% | 14.00% |
| Example 31 - Ingredient Family 31 | | | | | | | | | | |
| Geraniol | Geraniol 60 | 3.28% | 62.38% | 16.41% | 49.23% | 25.26% | 39.38% | 29.54% | 36.10% | 32.82% |
| Vanillin | Vanillin | 0.75% | 14.21% | 3.74% | 11.22% | 5.98% | 8.98% | 6.73% | 8.23% | 7.48% |
| Isopropyl myristate | Isopropyl myristate | 3.18% | 60.36% | 15.89% | 47.66% | 25.42% | 38.12% | 28.59% | 34.95% | 31.77% |
| Triethyl citrate | Triethyl citrate | 2.79% | 53.07% | 13.97% | 41.90% | 22.34% | 33.52% | 25.14% | 30.72% | 27.93% |
| Example 32 - Ingredient Family 32 | | | | | | | | | | |
| Geraniol | Geraniol 60 | 0.38% | 7.28% | 1.92% | 5.75% | 3.06% | 4.60% | 3.45% | 4.21% | 3.83% |
| Thyme Oil | Thyme Oil White | 3.35% | 63.65% | 16.75% | 50.25% | 26.80% | 40.20% | 30.15% | 36.85% | 33.50% |
| Thymol ester | Thymyl acetate | 0.43% | 8.23% | 2.17% | 6.50% | 3.46% | 5.20% | 3.90% | 4.76% | 4.33% |
| Linalool ester | Linalyl acetate | 0.81% | 15.30% | 4.03% | 12.08% | 6.44% | 9.66% | 7.25% | 8.86% | 8.05% |
| Tetrahydrolinalool | Tetrahydrolinalool | 0.72% | 13.72% | 3.61% | 10.83% | 5.78% | 8.66% | 6.50% | 7.94% | 7.22% |
| Vanillin | Vanillin | 0.04% | 0.84% | 0.22% | 0.66% | 0.53% | 0.35% | 0.40% | 0.48% | 0.44% |
| Isopropyl myristate | Isopropyl myristate | 0.74% | 14.08% | 3.71% | 11.12% | 5.93% | 8.89% | 6.67% | 8.15% | 7.41% |
| Piperonal | Piperonal (aldehyde) | 0.87% | 16.57% | 4.36% | 13.08% | 6.98% | 10.46% | 7.85% | 9.59% | 8.72% |
| Triethyl citrate | Triethyl citrate | 0.74% | 14.12% | 3.72% | 11.15% | 5.94% | 8.92% | 6.69% | 8.17% | 7.43% |
| Mineral Oil | White Mineral Oil | 1.91% | 36.23% | 9.54% | 28.61% | 15.26% | 22.88% | 17.16% | 20.98% | 19.07% |
| Example 33 - Ingredient Family 33 | | | | | | | | | | |
| Geraniol | Geraniol 60 | 1.99% | 37.81% | 9.95% | 29.85% | 15.96% | 23.88% | 17.91% | 21.89% | 19.90% |
| Thyme Oil | Thyme Oil White | 4.19% | 79.61% | 20.95% | 62.85% | 33.52% | 50.28% | 37.71% | 46.09% | 41.90% |
| Isopropyl myristate | Isopropyl myristate | 3.83% | 72.77% | 12.45% | 57.45% | 30.64% | 4.5.96% | 34.47% | 42.13% | 38.30% |
| Mineral Oil | White Mineral Oil | 3.52% | 66.88% | 17.60% | 52.80% | 28.16% | 42.24% | 31.68% | 38.72% | 35.20% |
| Example 34 - Ingredient Family 34 | | | | | | | | | | |
| Wintergreen Oil | Wintergreen Oil | 4.51% | 85.73% | 22.56% | 67.68% | 36.10% | 54.14% | 40.61% | 49.63% | 45.12% |
| Isopropyl Myristate | Isopropyl Myristate | 3.43% | 65.15% | 17.15% | 51.44% | 27.43% | 41.15% | 30.86% | 37.72% | 34.95% |
| Thyme Oil | Thyme Oil White | 2.06% | 39.12% | 10.30% | 30.89% | 16.47% | 24.71% | 18.53% | 22.65% | 20.59% |
| Mineral Oil | White Mineral Oil | 3.50% | 66.41% | 17.48% | 52.43% | 27.96% | 41.94% | 31.46% | 38.46% | 34.95% |
| Example 35 - Ingredient Family 35 | | | | | | | | | | |
| Wintergreen Oil | Wintergreen Oil | 4.47% | 84.93% | 22.35% | 67.05% | 35.76% | 53.64% | 40.23% | 49.17% | 44.70% |
| Isopropyl Myristate | Isopropyl Myristate | 0.34% | 6.46% | 1.70% | 5.10% | 2.72% | 4.08% | 3.06% | 3.74% | 3.40% |
| Thyme Oil | Thyme Oil White | 2.04% | 38.76% | 15.75% | 47.25% | 25.20% | 37.08% | 28.35% | 34.65% | 20.40% |
| Mineral Oil | White Mineral Oil | 3.15% | 59.85% | 15.75% | 47.25% | 25.20% | 37.80% | 28.35% | 34.65% | 31.50% |
| Example 36 - Ingredient Family 36 | | | | | | | | | | % (w/w) |
| Thymol ester | Thymyl Octanoate | 7.52% | 99.00% | 37.58% | 99.00% | 60.13% | 90.20% | 67.64% | 82.68% | 75.16% |
| p-cymene | p-cymene | 0.82% | 15.62% | 4.11% | 12.33% | 6.58% | 9.86% | 7.40% | 9.04% | 8.22% |
| Alpha-pinene | Alpha-pinene | 0.43% | 8.15% | 2.15% | 6.44% | 3.43% | 5.15% | 3.86% | 4.72% | 4.29% |
| Linalool ester | Linalyl acetate | 1.23% | 23.43% | 6.17% | 18.50% | 9.86% | 12.33% | 11.10% | 13.56% | 12.33% |
| Example 37 - Ingredient Family 37 | | | | | | | | | | |
| Thymol ester | Thymyl Octanoate | 7.42% | 99.00% | 37.08% | 99.00% | 59.33% | 88.99% | 66.74% | 81.58% | 74.16% |
| p-cymene | p-cymene | 0.86% | 16.26% | 4.28% | 12.84% | 6.85% | 10.27% | 7.07% | 9.42% | 8.56% |
| Alpha-pinene | Alpha-pinene | 0.42% | 7.90% | 2.08% | 6.24% | 3.33% | 4.99% | 3.74% | 4.58% | 4.16% |
| Linalool ester | Linalyl acetate | 1.31% | 24.93% | 6.56% | 19.68% | 10.47% | 15.74% | 11.81% | 14.43% | 13.12% |
| Example 38 - Ingredient Family 38 | | | | | | | | | | |
| Thymol ester | Thymyl Palmitate | 7.68% | 99.00% | 38.38% | 99.00% | 61.41% | 92.11% | 69.08% | 84.44% | 76.76% |
| p-cymene | p-cymene | 0.81% | 15.41% | 4.06% | 12.17% | 6.49% | 9.73% | 7.30% | 8.92% | 8.11% |
| Alpha-pinene | Alpha-pinene | 0.38% | 7.16% | 1.89% | 5.67% | 3.02% | 4.54% | 3.40% | 4.16% | 3.78% |
| Linalool ester | Linalyl acetate | 1.14 | 21.57% | 5.68% | 17.03% | 9.08% | 13.62% | 10.22% | 12.49% | 11.35% |
| Example 39 - Ingredient Family 39 | | | | | | | | | | |
| Thymol ester | Thymyl Acetate | 6.39% | 99.00% | 31.96% | 95.88% | 51.14% | 76.70% | 57.53% | 70.31% | 63.92% |
| Linalool ester | Linalyl Acetate | 1.45% | 27.61% | 7.27% | 21.80% | 11.62% | 17.44% | 13.08% | 15.98% | 14.53% |
| para-Cymene | para-Cymene | 1.28% | 24.28% | 6.39% | 19.17% | 10.22% | 15.34% | 11.50% | 14.06% | 12.78% |
| alpha-Pinene | alpha-Pinene | 0.88% | 16.66% | 4.39% | 13.16% | 7.02% | 10.52% | 7.89% | 9.65% | 8.77% |
| Example 40 - Ingredient Family 40 | | | | | | | | | | |
| Thymol | Thymol | 0.18% | 3.42% | 0.90% | 2.70% | 1.44% | 2.16% | 1.62% | 1.98% | 1.80% |
| Thymol ester | Thymyl Palmitate | 7.43% | 99.00% | 37.14% | 99.00% | 59.42% | 89.14% | 66.85% | 81.71% | 74.28% |
| Linalool ester | Linalyl Acetate | 1.29% | 24.59% | 6.47% | 19.41% | 10.35% | 15.53% | 11.65% | 14.23% | 12.94% |
| para-Cymene | para-Cymene | 0.73% | 13.91% | 3.66% | 10.98% | 5.86% | 8.78% | 6.59% | 8.05% | 7.32% |
| alpha-Pinene | alpha-Pinene | 0.37% | 6.95% | 1.83% | 5.49% | 2.93% | 4.39% | 3.29% | 4.03% | 3.66% |

### Example 1

### Pesticidal Use of Geraniol/Isopropyl Myristate/Thyme Oil White in a Microemulsion Formulation Against German Cockroaches

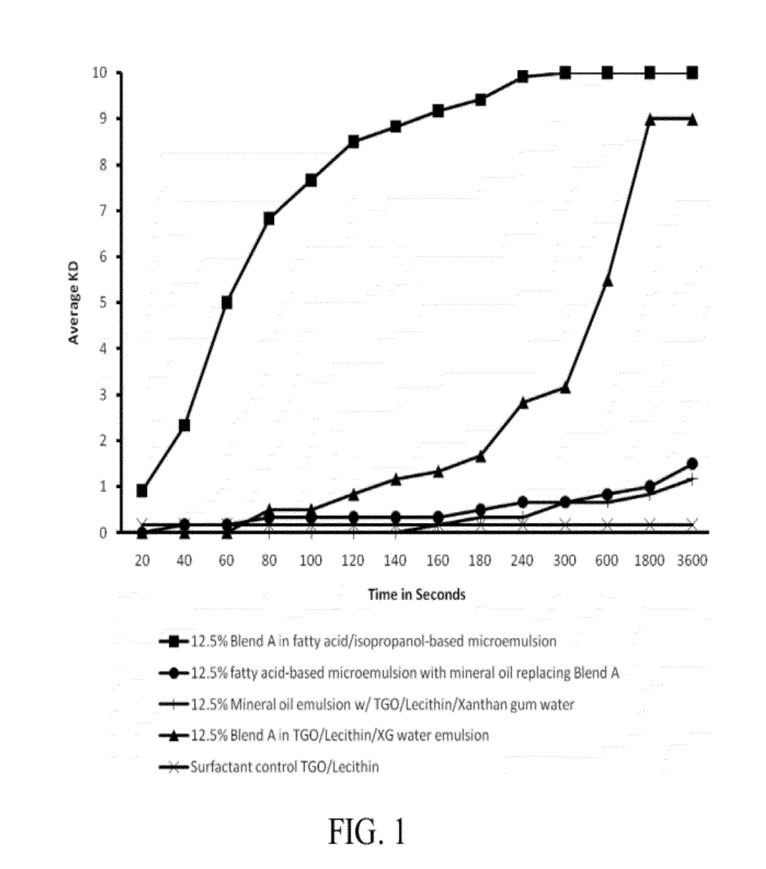

With respect to FIGS. 1-3 herein, microemulsion-based formulations were prepared containing concentrations of 12.5%, 6.25% and 3.125% of a blend (termed Blend A, and falling within the scope of Blend 38 in Table 1 and Ingredient Family 25 in Table 2) comprising geraniol in an amount within a range of 29.6-30.2%, preferably 29.9%; thyme oil white in an amount within a range of 31.3-31.9%, preferably 31.6%; and isopropyl myristate in an amount within a range of 38.1-38.9%, preferably 38.5% (all percentages wt/wt). The formulation agent employed, along with similar agents, is a fatty acid-based microemulsion agent. In this case, the formulation agent was a 50:50% by weight mixture of oleic acid, an unsaturated fatty acid, and a mixture (50:50% by weight) of capric acid and caprylic acid, which are saturated fatty acids. The formulation was prepared in the following manner: Blend A, the formulation agent, and isopropanol were combined in a 3:4:2 ratio, the mixture was stirred for 45 minutes, and then the mixture was titrated with 26.6% KOH to a pH of approximately 8.0. NaOH can also be used to neutralize the acidic formulation agent.

Formulations of the same Blend A at the same concentrations were also prepared using the emulsifying agents tetraglycerol oleate and lecithin. Specifically, 1% tetraglycerol oleate (TGO), 1% lecithin, 2.5% isopropyl alcohol, 2.11% xanthan gum (XG), and the relevant amount of the blend were combined in a manner similar to that set forth above, with water making up the balance of the formulation.

The six formulations that resulted were sprayed onto German cockroaches, and knockdown data were obtained over time. Those data are shown in FIGS. 1-3, along with data obtained for control compositions (e.g. emulsions in which inert mineral oil replaced Blend A). FIG. 1 depicts the knockdown data obtained for the formulations containing a 12.5% concentration of Blend A. As can be seen from the figure, the formulation employing the fatty acid-based microemulsion exhibited much better knockdown effects than the TGO/Lecithin/XG water-based formulation or any of the control formulations. Specifically, the fatty acid-based microemulsion containing Blend A exhibits a KT50 value of approximately 60 seconds and a KT90 value of approximately 157 seconds, respectively. This represents much quicker knockdown than the TGO/Lecithin/XG water-based formulation of Blend A, which exhibited KT50 and KT90 values of 630 and 3200 seconds, respectively. Furthermore, the control TGO/Lecithin/XG emulsion of mineral oil exhibited KT50 and KT90 values of approximately 72,200 and 2.70E+06 seconds, respectively, while the control fatty acid-based microemulsion of mineral oil exhibited KT50 and KT90 values of 3.56E+05 and 1.06E+08 seconds, respectively.

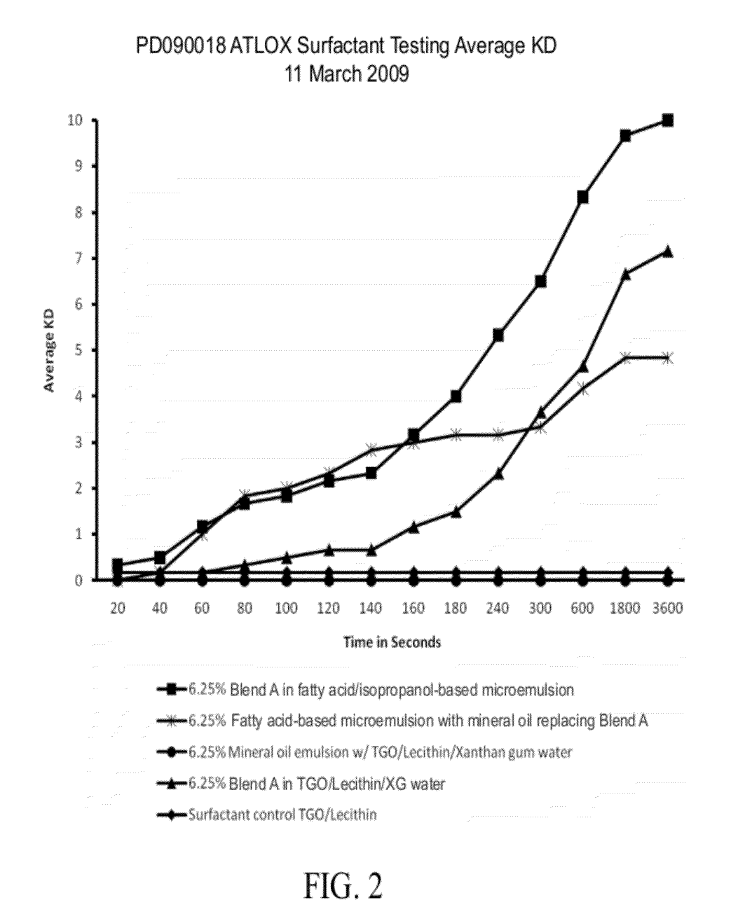

FIG. 2 depicts the knockdown data obtained for the formulations containing a 6.25% concentration of Blend A. As can be seen from the figure, the formulation employing the fatty acid-based microemulsion exhibited much better knockdown effects than the TGO/Lecithin/XG water-based formulation or any of the control formulations. Specifically, the fatty acid-based microemulsion containing Blend A exhibits a KT50 value of 237 and a KT90 value of 937 seconds. This represents much quicker knockdown than the TGO/Lecithin/XG water-based formulation of Blend A, which exhibited KT50 and KT90 values of 944 and 7053 seconds, respectively. Furthermore, the control TGO/Lecithin/XG emulsion of mineral oil exhibited KT50 and KT90 values of 1790 and 147,050 seconds, respectively.

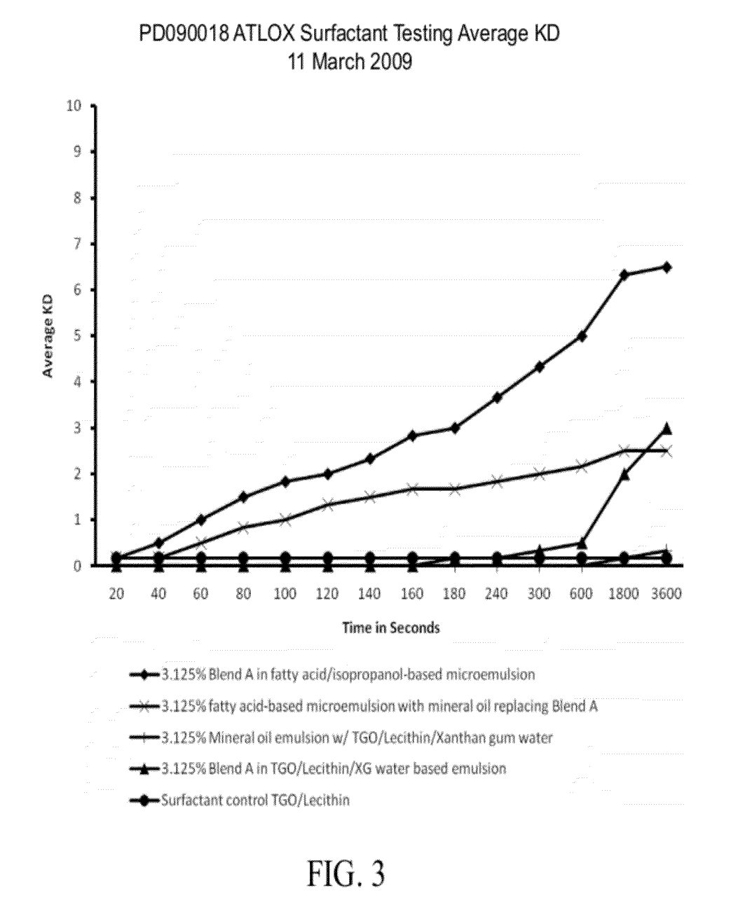

FIG. 3 depicts the knockdown data obtained for the formulations containing a 3.125% concentration of Blend A. As can be seen from the figure, the formulation employing the fatty acid-based microemulsion exhibited better knockdown effects than the TGO/Lecithin/XG water-based formulation or any of the control formulations. Specifically, the fatty acid-based microemulsion containing Blend A exhibits a KT50 value of 763 and a KT90 value of 13966 seconds. This represents quicker knockdown than the TGO/Lecithin/XG water-based formulation of Blend A, which exhibited KT50 and KT90 values of 7237 and 51,445 seconds, respectively. Furthermore, the control fatty acid-based microemulsion of mineral oil exhibited KT50 and KT90 values of 24445 and 6.42E+06 seconds, respectively, while the control TGO/Lecithin/XG emulsion of mineral oil exhibited KT50 and KT90 values of 4.40E+04 and 2.67E+05 seconds, respectively.

### Example 2

### Pesticidal Use of Wintergreen Oil/Isopropyl Myristate/Thyme Oil White/Thyme Oil Red in a Microemulsion Formulation Against Harvester Ants

A microemulsion-based formulation was prepared containing a 10% concentration of a blend (termed Blend B, and falling within the scope of Blend 35 in Table 1) comprising wintergreen oil in an amount of approximately 45.1%, a 99:1 mixture of thyme oil white and thyme oil red in an amount of approximately 20.6%, and isopropyl myristate in an amount of approximately 34.3% (all percentages wt/wt). The formulation agent used in Example 1 was also used in Example 2. The formulation was prepared in the same way as in Example 1, with the exception that 10% of Blend B was used. A formulation of the same Blend B at the same concentration was also prepared using the emulsifying agents tetraglycerol oleate and lecithin, in the same manner as described in Example 1.

The six formulations that resulted were sprayed onto harvester ants, and knockdown data were obtained over time. The results demonstrated that the efficacy of the active ingredients in the fatty acid-based microemulsion was approximately double that of those in the TGO/Lecithin/XG-based water emulsion.

### Example 3

### Pesticidal Use of Geraniol/Isopropyl Myristate/Thyme Oil White in a Microemulsion Formulation Against Various Insect Species

With reference to Table 3 below, formulations containing 6.1% and 7.7% concentrations of Blend A in the fatty acid-based microemulsion formulation of Example 1 were compared to a formulation containing a 3.1% concentration of Blend B in the TGO/Lecithin/XG emulsion formulation described above. Table 3 shows knockdown data obtained at 0.3 minutes after application of the formulation, and kill data obtained at 1 and 5 minutes after application. Although the comparison is not exact, given the different blend compositions and concentrations, the results in Table 3 are indicative of enhanced pesticide efficacy of the fatty acid-based microemulsion formulation in each of the following insect species: American cockroaches, Argentine ants, big-headed ants, bed bugs, cat fleas, crazy ants, diamondback moth, Eastern subterranean termites, flour beetles, German cockroaches, ghost ants, honey bees, house crickets, house flies, house spiders, mealworm (darkling beetle adult), mealworm (darkling beetle larvae), millipedes, pharaoh ants, red imported fire ants, yellow fever mosquitoes, lesser grain borers, and brown dog ticks.

TABLE 3

| | | 6.1% | | |
|---|---|---|---|---|
| | | Blend A | 7.7% | 3.1% |
| | | in fatty | Blend A | Blend B in |
| | Time | acid-based | in fatty acid- | TGO/lecithin/XG |
| Insect Species | (min) | ME | based ME | water emulsion |
| American | 0.3 | 45 | 3 | 0 |
| cockroaches, | | | | |
| Periplaneta | 1 | 89 | 81 | 67 |
| americana | | | | |
| | 5 | 97 | 97 | 94 |
| Argentine ants, | 0.3 | 80 | 75 | 60 |
| Linepthema | 1 | 100 | 100 | 100 |
| humile | | | | |
| | 5 | 100 | 100 | 100 |
| Big-headed ants, | 0.3 | 45 | 58 | 28 |
| Pheidole sp. | 1 | 83 | 78 | 67 |
| | 5 | 100 | 100 | 100 |
| Bed bugs, | 0.3 | 90 | 98 | 3 |
| Cimex lectularis | 1 | 95 | 100 | 39 |
| | 5 | 100 | 100 | 60 |
| Cat fleas, | 0.3 | 50 | 68 | 50 |
| Ctenocephalides | 1 | 100 | 98 | 85 |
| felis | | | | |
| | 5 | 88 | 100 | 100 |
| Crazy ant, | 0.3 | 58 | 58 | 60 |
| Paratrechina | 1 | 88 | 88 | 67 |
| longicornis | | | | |
| | 5 | 100 | 100 | 100 |
| Diamondback | 0.3 | 47 | 27 | 20 |
| moth, | | | | |
| Plutella xylostella | 1 | 67 | 57 | 87 |
| | 5 | 100 | 100 | 100 |
| Eastern | 0.3 | 62 | 78 | 45 |
| subterranean | | | | |
| termites, | | | | |
| Reticulitermes | 1 | 90 | 100 | 100 |
| flavipes | | | | |
| | 5 | 100 | 100 | 100 |
| Flour beetles, | 0.3 | 0 | 18 | 8 |
| Tribolium sp. | 1 | 85 | 98 | 63 |
| | 5 | 100 | 100 | 100 |
| German | 0.3 | 83 | 90 | 90 |
| cockroaches, | | | | |
| Blattella | 1 | 100 | 100 | 93 |
| germanica | | | | |
| | 5 | 100 | 100 | 100 |
| Ghost ants, | 0.3 | 95 | 97 | 83 |
| Tapinoma | 1 | 100 | 100 | 100 |
| melanocephalum | | | | |
| | 5 | 100 | 100 | 100 |
| Honey bees, | 0.3 | 5 | 15 | 5 |
| Apis mellifera | 1 | 55 | 75 | 35 |
| | 5 | 100 | 100 | 100 |
| House Crickets, | 0.3 | 0 | 3 | 2 |
| Acheta domesticus | 1 | 62 | 37 | 13 |
| | 5 | 100 | 100 | 95 |
| House flies, | 0.3 | 88 | 88 | 0 |
| Musca domestica | 1 | 93 | 98 | 23 |
| | 5 | 100 | 100 | 90 |
| House spiders, | 0.3 | n/a | 30 | 20 |
| Family Lycosidae | 1 | n/a | 70 | 60 |
| | 5 | n/a | 100 | 100 |
| Mealworm | 0.3 | 0 | 0 | 0 |
| (darkling beetle | | | | |
| adult), | | | | |
| Tenebrio molitor | 1 | 3 | 7 | 0 |
| | 5 | 93* | 77* | 7 |
| Mealworm | 0.3 | 37 | 23 | 22 |
| (darkling beetle | 1 | 97 | 87 | 53 |
| larvae), | | | | |
| Tenebrio molitor | 5 | 100 | 100 | 100 |
| Millipedes, | 0.3 | 5* | 0* | 0 |
| Order Diplopoda | 1 | 10 | 0 | 0 |
| | 5 | 10 | 20 | 0 |
| Pharaoh ants, | 0.3 | 100 | 98 | 25 |
| Monomorium | 1 | 100 | 98 | 85 |
| pharaonis | | | | |
| | 5 | 100 | 100 | 100 |
| Red imported fire | 0.3 | 0 | 0 | 0 |
| ants, | | | | |
| Solenopsis invicta | 1 | 0 | 3 | 5 |
| | 5 | 95 | 83 | 50 |
| Yellow fever | 0.3 | 100 | 100 | 98 |
| mosquitoes, | | | | |
| Aedes aegypti | 1 | 100 | 100 | 98 |
| | 5 | 100 | 100 | 100 |
| Lesser Grain | 0.3 | 18 | 32 | 23 |
| Borer, | | | | |
| Rhyzopertha | 1 | 70 | 98 | 88 |
| dominica | | | | |
| | 5 | 100 | 100 | 100 |
| Brown Dog Ticks, | 0.3 | 0 | 0 | 0 |
| Rhipicephalus | 1 | 40 | 20 | 30 |
| sanguineus | | | | |
| | 5 | 100 | 100 | 100 |

*indicates 100% control after 24 hours

### Example 4

### Pesticidal Use of Geraniol/Isopropyl Myristate/Thyme Oil White in a Microemulsion Formulation Against Tenebrio molitor

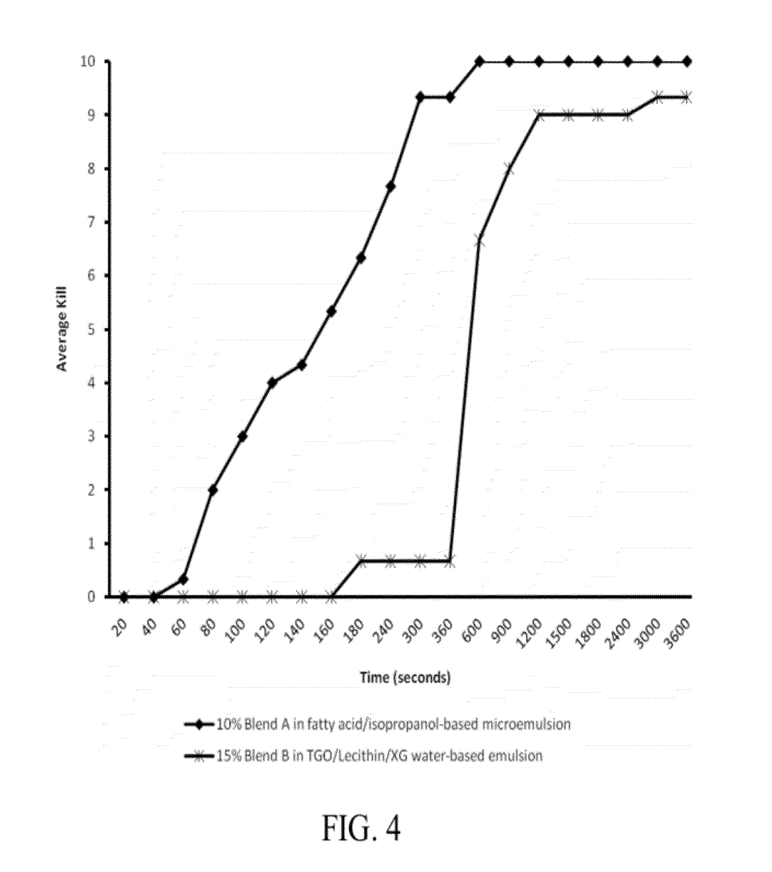

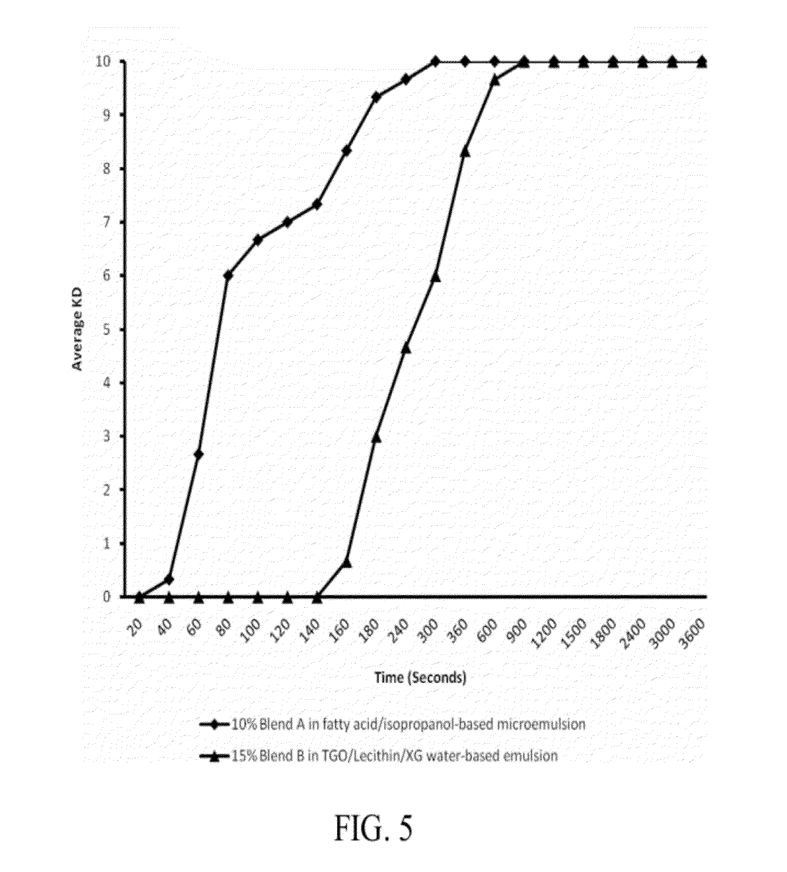

With respect to FIGS. 4 and 5, microemulsion-based formulations were prepared containing 10% concentrations of Blend A in the fatty acid-based microemulsion formulation of Example 1 above and tested for knockdown and kill time when administered against Tenebrio molitor. These results were compared to a 15% concentration of Blend B in the TGO/Lecithin/XG emulsion formulation described above.

As depicted in FIGS. 4 and 5, these formulations were sprayed onto Tenebrio molitor, and average kill (FIG. 4) and average knockdown (FIG. 5) data was obtained over time. As can be seen from both figures, the formulation employing the fatty acid-based microemulsion salts exhibited much better average kills and knockdown effects than the TGO/Lecithin water-based formulation. This was especially surprising given the higher concentration of active agent in the TGO/Lecithin/XG emulsion formulation. Specifically, with regard to FIG. 4, at 80 seconds, 100 seconds, and 300 seconds, the fatty acid-based microemulsion containing Blend A resulted in average kill of approximately 2, 3, and 9 (out of 10 insects). This represents a much quicker kill time than the TGO/Lecithin/XG water-based formulation of Blend B, which at 80 seconds, 100 seconds, and 300 seconds, exhibited average kill data of approximately 0, 0, and 1 (see FIG. 4). Similarly, with regard to FIG. 5, at 80 seconds, 100 seconds, and 300 seconds, the fatty acid-based microemulsion containing Blend A resulted in average knockdown of approximately 6, 6, and 10. This demonstrates a much quicker knockdown than the TGO/Lecithin water-based formulation of Blend B, which at 80 seconds, 100 seconds, and 300 seconds, exhibited average knockdown of approximately 0, 0, and 6.

### Example 5

### Pesticidal Use of Geraniol/Isopropyl Myristate/Thyme Oil White in a Microemulsion Formulation Against German Cockroaches

### Residual Effects

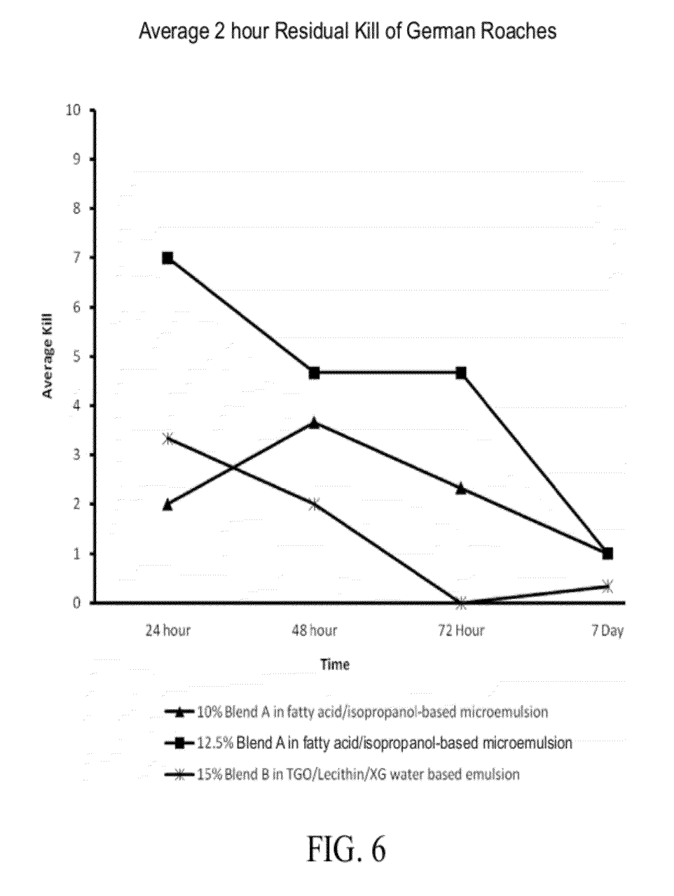

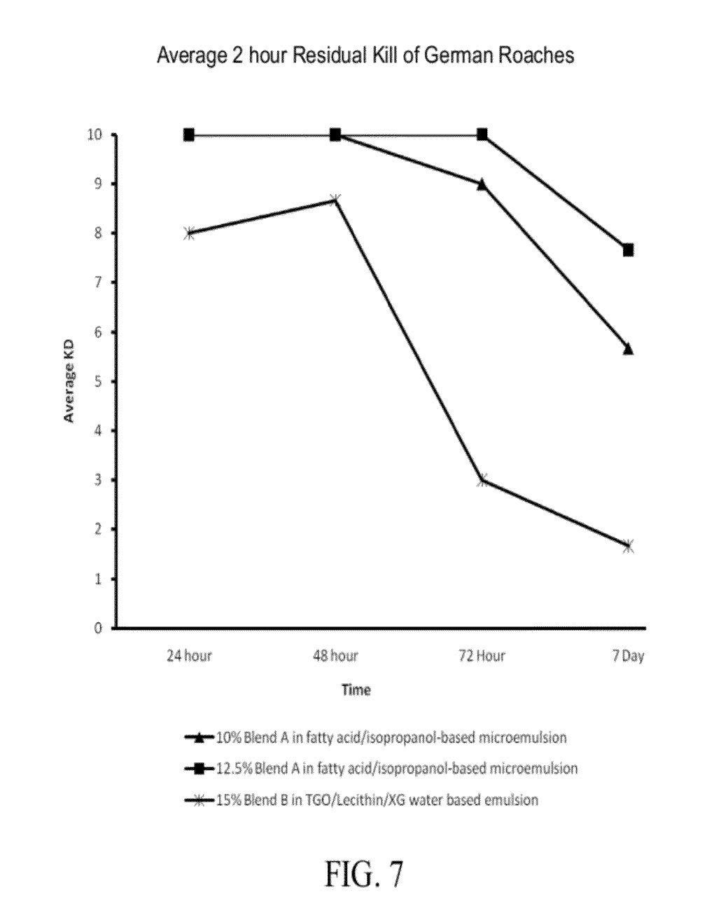

With respect to FIGS. 6 and 7, microemulsion-based formulations were prepared containing 10% and 12.5% concentrations of Blend A in the fatty acid-based microemulsion formulation of Example 1 above. A formulation containing a 15% concentration of Blend B in the TGO/Lecithin/XG emulsion formulation described above was also prepared.

As depicted in FIGS. 6 and 7, these formulations were utilized in determining the exposure residual knockdown (FIG. 6) and kill (FIG. 7) effect on German roaches. Each formulation was applied to a surface, and 10 insects were exposed to the treated surface for 2 hours at 24, 48, and 72 hours after application, and at 7 days after application. As seen in both figures, Blend A in the fatty acid-based microemulsion formulation demonstrates a significantly greater residual effects than the TGO/Lecithin/XG water-based formulation of Blend B, which is particularly surprising given the higher concentration of active ingredient in the latter formulation. With respect to FIG. 6, the 10% concentration of Blend A in the fatty acid-based microemulsion formulation, at 48 hours, 72 hours, and 7 days after application, resulted in approximately 4, 2, and 1 average knockdown, respectively; and the 12.5% concentration of Blend A in the fatty acid-based microemulsion formulation, at 48 hours, 72 hours, and 7 days, resulted in approximately 5, 5 and 1 average knockdown, respectively. In general, this is a significantly higher residual knockdown effect than the TGO/Lecithin/XG water-based formulation of Blend B, which at 48 hours, 72 hours, and 7 days, only resulted in approximately 2, 0, and 0 average knockdown, respectively. Similarly, with respect to FIG. 7, exposure to the 10% concentration of Blend A in the fatty acid-based microemulsion formulation, at 48 hours, 72 hours, and 7 days, resulted in approximately 10, 10, and 8 average kills, respectively; and the 12.5% concentration of Blend A in the fatty acid-based microemulsion formulation, at 48 hours, 72 hours, and 7 days, resulted in approximately 10, 9, and 6 average kills, respectively. In general, this demonstrates a significantly higher residual kill effect than the TGO/Lecithin/XG water-based formulation of Blend B, which at 48 hours, 72 hours, and 7 days, resulted in approximately 9, 3, and 2 average kills, respectively.

### Example 6

### Pesticidal Use of Geraniol/Isopropyl Myristate/Thyme Oil White in a Microemulsion Formulation

### Extended Residual Effects

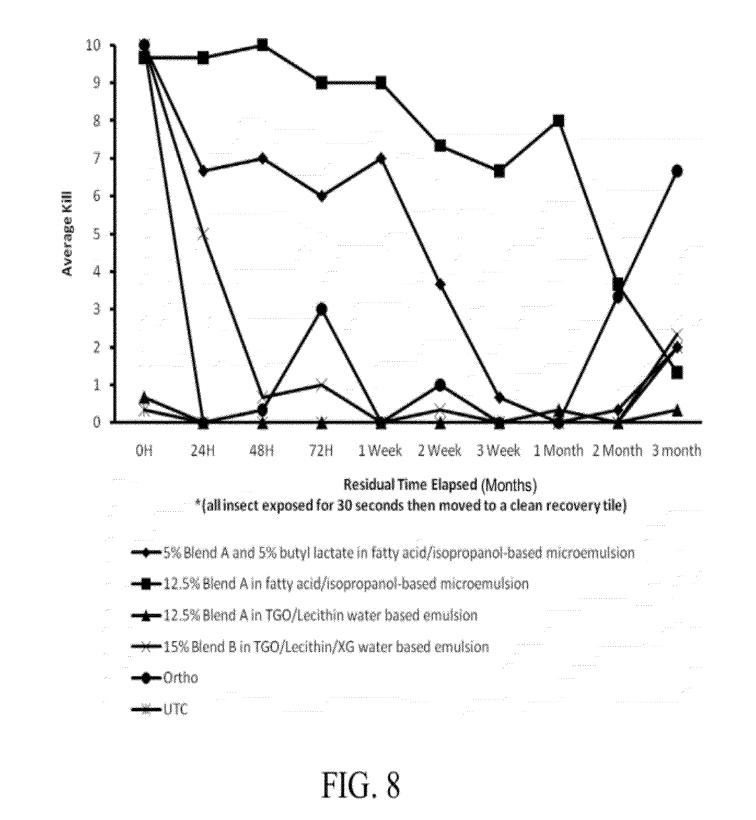

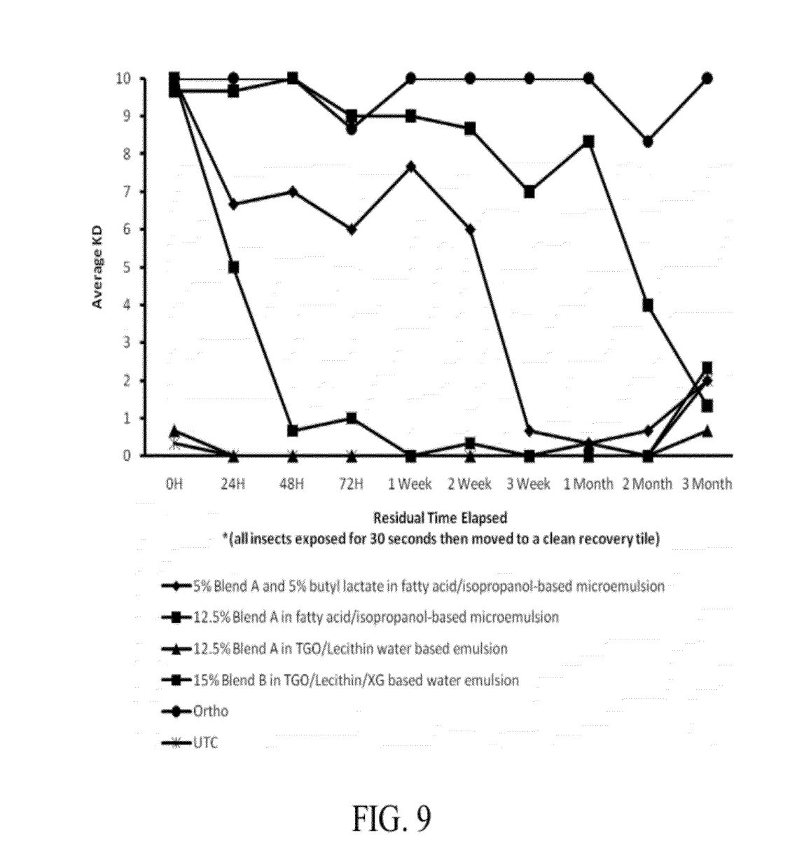

With respect to FIGS. 8 and 9, microemulsion-based formulations were prepared containing concentrations of 5% and 12.5% and 3.125% of Blend A, comprising geraniol in an amount within a range of 29.6-30.2%, preferably 29.9%; thyme oil white in an amount within a range of 31.3-31.9%, preferably 31.6%; and isopropyl myristate in an amount within a range of 38.1-38.9%, preferably 38.5% (all percentages wt/wt). The microemulsion containing 5% of Blend A also contained 5% butyl lactate. The formulation agent employed, along with similar agents, was a fatty acid-based microemulsion agent. In this case, the formulation agent was a 50:50% by weight mixture of oleic acid, an unsaturated fatty acid, and a mixture (50:50% by weight) of capric acid and caprylic acid, which are saturated fatty acids. The formulation was prepared in the following manner: Blend A, the formulation agent, and isopropanol were combined in a 3:4:2 ratio, the mixture was stirred for 45 minutes, and then the mixture was titrated with 26.6% KOH to a pH of approximately 8.0. NaOH can also be used to neutralize the acidic formulation agent.

A formulation of the same Blend A at a concentration of 12.5% was also prepared using the emulsifying agents tetraglycerol oleate and lecithin. Specifically, 1% tetraglycerol oleate (TGO), 1% lecithin, 2.5% isopropyl alcohol, 2.11% xanthan gum (XG), and the relevant amount of the blend were combined in a manner similar to that set forth above, with water making up the balance of the formulation. In addition, the 15% concentration of Blend B in the TGO/Lecithin/XG emulsion formulation described above was also prepared. A commercial product (“Ortho”) was also used for comparison.

The various formulations that resulted were sprayed onto surfaces and allowed to dry. German cockroaches were then placed on the surfaces for a period of 30 seconds at intervals out to 3 months after application, and kill and knockdown data were obtained over time. Those data are shown in FIGS. 8 and 9, along with data obtained for control compositions (e.g. emulsions in which inert mineral oil replaced Blend A). FIG. 1 depicts the knockdown data obtained for the formulations containing a 12.5% concentration of Blend A. As can be seen from the figures, the formulation employing the fatty acid-based microemulsion exhibited much greater residual knockdown effects than the TGO/Lecithin/XG water-based formulations. Knockdown effects of the fatty acid-based formulations were comparable even to the commercial product for some weeks, while the kill effect of those formulations was superior as long as two months after application.

### Example 7

### Pesticidal Use of Geraniol/Isopropyl Myristate/Thyme Oil White in a Microemulsion Formulation

### Repellency Effects

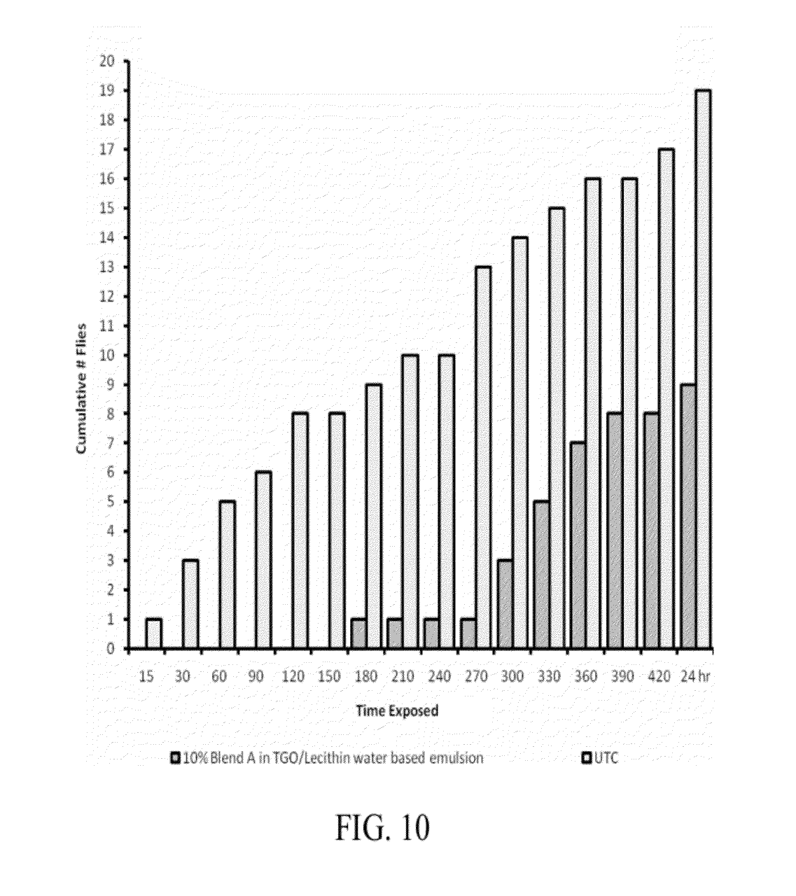

With respect to FIG. 10, a fatty acid-based microemulsion formulation was prepared containing a concentrations of 10% of Blend A. This was assessed for repellency of flies in accordance with the following protocols. The first protocol involved a paired comparison test with two treatments: the formulation of Blend A, and an untreated control. The two treatments were contained within a screened 8 cubic foot box. 50 flies were placed in the screened box with the treatments. Two treated filter papers were treated with the indicated treatment and placed in the box. The treated filter paper surrounded a sugar water solution in a cup to attract the flies. A camera placed above the box recorded fly landings on the filter paper for 24 hrs. At the time points indicated in FIG. 10, a one-minute subsample of the film was taken and the number of flies that landed on the filter paper were counted. A lower fly count was indicative of a higher degree of repellency. As can be seen from FIG. 10, the fatty acid-based formulation of Blend A (on the left-hand side at each time point) exhibited greater repellency than untreated controls throughout the duration of the testing.

In another protocol, testing was conducted using horses. 4 horses were used; one for each of 4 different treatments. Sprays were prepared using 2 ounces and 3 ounces of the 10% formulation of Blend A described above, and a commercial product (Absorbine Ultrashield®), along with water, were used for comparison. All horses were treated with 2 oz of the individual spray, except on the face. Two different counters counted flies on the horse at the time points indicated in the graph (1 hr prior to treatment, and 1, 20, 22, and 24 hours after treatment). Counts were scored as flies landing on the front quarter of the horse, with any landing counting as a positive hit. Counts from the two individuals were averaged and expressed as a percentage repellency based on the results for the control. After 72 hours, the horses were washed and treatments were rotated to a different horse, and the counts repeated until all four horses had been treated with each treatment. The study was double blind.

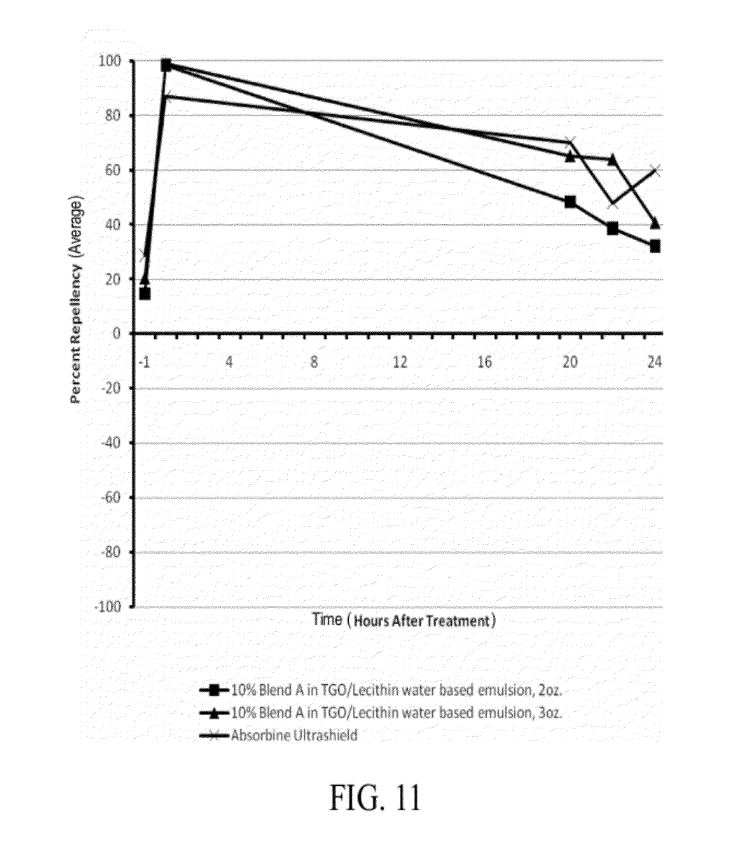

As can be seen from FIG. 11, the formulations of Blend A exhibited repellency over time that was comparable to that of the commercial product.

### Example 8

### Alternate Fatty Acid-Based Formulation

A formulation of Blend A was produced as described in Example 1 above, except that 36 g of a 28:72% by weight fatty acid mixture of the oleic acid and capric acid/caprylic acid, 7.5 g isopropanol, 15 g of the essential oil mixture, and 3 g of butyl lactate were used. 132 g of 7.5% by weight aqueous potassium hydroxide solution was used to adjust the pH to be between 8.0 and 8.3. 106 g of water was added, and the pH, after mixing, was again between 8.0 and 8.3. This formulation of Blend A, at the same concentrations as in Examples 1-7 above, exhibits similar results.

One of ordinary skill in the art will recognize that modifications and variations are possible without departing from the teachings of the invention. This description, and particularly the specific details of the exemplary embodiments disclosed, is provided primarily for clearness of understanding and no unnecessary limitations are to be understood therefrom, for modifications and other embodiments will become evident to those skilled in the art upon reading this disclosure and can be made without departing from the spirit or scope of the claimed invention.

1. A method of controlling a target pest, comprising:
providing a microemulsion pesticide formulation comprising an active pest control ingredient and a microemulsifying agent, wherein the microemulsifying agent comprises a mixture of unsaturated C12-C26 fatty acids and/or salts thereof and saturated C6-C14 fatty acids and/or salts thereof, and the active pest control ingredient comprises two or more compounds that act synergistically to control the target pest; and
applying an effective amount of the microemulsion pesticide formulation to the target pest or to a surface associated with the target pest.

2. The method of claim 1, wherein the active pest control ingredient and the microemulsifying agent act synergistically to control the target pest.

3. The method of claim 1, wherein the active pest-control ingredient comprises a synergistic combination of at least 2 ingredients from an ingredient family, wherein the ingredient family is an Ingredient Family listed in Table 2.

4. The method of claim 3, wherein the active pest-control ingredient comprises a synergistic combination of at least 3 ingredients from the ingredient family when said ingredient family has at least 3 ingredients.

5. The method of claim 3, wherein the active pest-control ingredient comprises a synergistic combination of at least 4 ingredients from the ingredient family when said ingredient family has at least 4 ingredients.

6. The method of claim 3, wherein the ingredients are present within a range specified in Range 1 of Table 2.

7. The method of claim 3, wherein the ingredients are present within a range specified in Range 2 of Table 2.

8. The method of claim 3, wherein the ingredients are present within a range specified in Range 3 of Table 2.

9. The method of claim 3, wherein the ingredients are present within a range specified in Range 4 of Table 2.

10. The method of claim 1, wherein the active pest-control ingredient comprises a blend listed in Table 1.

11. The method of claim 3, wherein the active pest control ingredient comprises isopropyl myristate, thyme oil or a derivative thereof, and an ingredient selected from the group consisting of wintergreen oil and geraniol.

12. The method of claim 3, wherein the unsaturated fatty acid is selected from the group consisting of oleic acid, ricinoleic acid, linoleic acid, linolenic acid, and mixtures thereof.

13. The method of claim 3, wherein the saturated fatty acid is selected from the group consisting of caprylic acid, capric acid, 2-ethyl hexanoic acid, trimethylhexanoic acid, trimethylnonanoic acid, tetramethylhexanoic acid, and mixtures thereof.

14. The method of claim 3, wherein the microemulsion pesticide formulation additionally comprises a cosolvent.

15. (canceled)

16. The method of claim 3, wherein the microemulsifying agent comprises a 50:50% by weight mixture of the unsaturated C12-C26 fatty acids and/or salts thereof and the saturated C6-C14 fatty acids and/or salts thereof.

17. The method of claim 16, wherein the unsaturated C12-C26 fatty acids and/or salts thereof comprise one selected from the group of: oleic acid, soya fatty acid, ricinoleic acid, and a 50:50% by weight mixture of oleic acid and ricinoleic acid.

18. The method of claim 16, wherein the saturated C6-C14 fatty acids and/or salts thereof comprise one selected from the group of: 2-ethyl hexanoic acid, trimethylhexanoic acid, and a 50:50% by weight mixture of capric acid and caprylic acid.

19-24. (canceled)

25. The method of claim 11, wherein the thyme oil or derivative thereof is a 99:1 mixture of thyme oil white and thyme oil red.

26-28. (canceled)

29. The method of claim 3, wherein the target pest is selected from the group consisting of American cockroach, Argentine ant, big-headed ant, bed bug, cat flea, crazy ant, darkling beetle, diamondback moth, Eastern subterranean termite, flour beetle, German cockroach, ghost ant, harvester ant, honey bee, house cricket, house fly, house spider, mealworm (larval darkling beetle), millipede, pharaoh ant, red imported fire ant, yellow fever mosquito, lesser grain borer, and brown dog tick.

30. The method claim 3, wherein the control is selected from the group consisting of kill, knockdown, and repellency.

31. The method claim 3, wherein the control exhibited by the microemulsion pesticide formulation persists for a first period of time, control exhibited by the active pest control ingredient without the microemulsifying agent persists for a second period of time, and the first period of time is greater than the second period of time.

32. The method of claim 31, wherein the first period of time is greater than the second period of time by a factor selected from the group consisting of 20%, 50%, 100%, 200%, 500%, and 1000%.
